(19) United States
(12) Patent Application Publication
(10) Pub. No.: US 2023/0250253 A1
(43) Pub. Date: Aug. 10, 2023

(54) PLASTIC POLYMER BIOCONVERSION PROCESS

(71) Applicant: GEORGIA STATE UNIVERSITY RESEARCH FOUNDATION, INC., Atlanta, GA (US)

(72) Inventors: Merhawi Mihreteab, Tucker, GA (US); Bryan Stubblefield, Atlanta, GA (US); Eric Gilbert, Decatur, GA (US)

(21) Appl. No.: 18/012,252

(22) PCT Filed: Jun. 25, 2021
(86) PCT No.: PCT/US2021/039128

§ 371 Date: Dec. 22, 2022

Related U.S. Application Data
(60) Provisional application No. 63/044,010, filed on Jun. 25, 2020.

(51) Int. Cl. C08J 11/10

(52) U.S. Cl. CPC C08J 11/105; C08J 2323/12

(57) ABSTRACT

Compositions and methods for reducing pollution from postconsumer wastes derived from a polymeric material are disclosed. The methods involve depolymerizing the polymeric material and optionally bioconverting the depolymerized polymeric material, the product of which can be used as feedstocks for other bioconversion processes to make biochemicals and other value-added biological products. In some embodiments, the depolymerized polymeric materials can be used to make a culture medium. The culture media are suitable for producing a bioproduct from microorganisms including bacterium, alga, and fungus or an enzyme.

### CROSS-REFERENCE TO RELATED APPLICATIONS

This application claims priority to U.S. Provisional Patent Application No. 63/044,010, filed Jun. 25, 2020, and entitled “PLASTIC POLYMER BIOCONVERSION PROCESS,” the entire disclosure of which is incorporated herein by reference.

### FIELD OF THE DISCLOSURE

This disclosure relates generally to culture media, particularly to recycling polymeric materials for preparing culture media.

### BACKGROUND OF THE DISCLOSURE

Polymeric materials such as plastics are highly useful, economical materials. In particular, plastics can be resistant to various types of environmental and chemical agents, thus allowing products made from them to maintain their integrity over long periods of time and over a wide variety of conditions. Additionally, many plastics are lightweight relative to their strength, making them practical for storage and transport. Conversely, the features that make plastics useful and economical result in their persistence and widespread distribution in the environment.

Commercially available plastics do not degrade or fully degrade in the environment. Typically, they are degraded through mechanical action into small pieces that retain their polymeric character. However, under natural conditions, microbial biotransformation of plastic polymers are generally limited. For example, as with many polymers, the large size of the molecules can interfere with uptake and catalysis by microorganisms. Additionally, the rate at which synthetic polymers are biodegraded may also be limited by their xenobiotic molecular structures. There is a need for reducing non-biodegradable materials in the environment. There is a particular need for methods for recycling polymeric materials. The compositions and methods described herein address these and other needs.

### SUMMARY OF THE DISCLOSURE

Compositions and methods for reducing pollution from postconsumer wastes derived from a polymeric material are disclosed. The methods involve depolymerizing the polymeric material and optionally bioconverting the depolymerized polymeric material, the product of which can be used as feedstocks for other bioconversion processes to make biochemicals and other value-added biological products. In some embodiments, the depolymerized polymeric materials can be used to make a culture medium. According, methods of making a culture medium from a polymeric waste material are disclosed.

In some aspects, methods of making a culture medium from a polyalkylene containing plastic material comprising a) pyrolyzing the polyalkylene containing plastic material to obtain a depolymerized residue, and b) mixing the depolymerized residue with an adjuvant selected from a biodegradable surfactant, a nitrogen source, a phosphate source, a carbohydrate source, a source of mineral, or a combination thereof to form a culture medium, are disclosed. In further aspects, methods of bioconverting a polyalkylene containing plastic material comprising a) pyrolyzing the polyalkylene containing plastic material to obtain a depolymerized residue, b) optionally mixing the depolymerized residue with an adjuvant selected from a surfactant, a nitrogen source, a phosphate source, a carbohydrate source, a source of mineral, or a combination thereof, to form a culture medium, c) introducing an enzyme or an organism into the culture medium, and d) accumulating at least one product produced by the enzyme or the organism, are disclosed.

The polyalkylene containing plastic material can include high and/or density polyalkylene containing plastic material. In some instances, the polyalkylene containing plastic material can be selected from polyethylene, polypropylene, or a combination thereof. In some instances, the polyalkylene containing plastic material comprises at least 50% by weight, at least 70% by weight, or consists essentially of polypropylene. The polyalkylene containing plastic material can be a plastic article, such as a plastic fibrous material. Pyrolyzing can include heating a neat or heterologous mixture of the polyalkylene containing plastic material to a temperature of 350° C. or greater, such as from 400° C. to 600° C., or from 400° C. to 500° C. The depolymerized residue obtained can comprise one or more branched C₆₋₃₆ alcohols, one or more branched C₆₋₃₆ alkenes, or combinations thereof. For example, the depolymerized residue can comprise at least 50% by weight, or at least 70% by weight, or consist essentially of the branched C₆₋₃₆ alcohols, branched C₆₋₃₆ alkenes, or combinations thereof.

In some aspects, methods of making a culture medium from a plastic material selected from polyester, polyurethane, or a combination thereof are disclosed. The methods can include a) heating the plastic material in an aqueous mixture having a pH of 10 or greater to obtain a depolymerized residue, and b) mixing the depolymerized residue with an adjuvant selected from a biodegradable surfactant, a nitrogen source, a phosphate source, a carbohydrate source, a source of mineral, or a combination thereof to form a culture medium having an acidic, neutral, or basic pH. In further aspects, methods of bioconverting a plastic material selected from polyester, polyurethane, or a combination thereof, are disclosed. The methods can include a) depolymerizing by heating the plastic material in an aqueous mixture having a pH of 10 or greater to obtain a depolymerized residue, b) mixing the depolymerized residue with an adjuvant selected from a surfactant, a nitrogen source, a phosphate source, a carbohydrate source, a source of mineral, or a combination thereof to form a culture medium, c) introducing an enzyme or an organism into the culture medium, and d) accumulating at least one product produced by the enzyme or the organism. The method can further comprise the step of centrifuging the depolymerized residues, filtering the depolymerized residues, washing the depolymerized residues, or a combination thereof, prior to mixing with an adjuvant.

In certain aspects, methods of making a culture medium from a plastic polyester material are disclosed. The methods can include a) heating the plastic polyester material in an aqueous mixture comprising an alcohol and having a pH of 10 or greater to obtain a depolymerized residue, b) mixing the depolymerized residue with water and optionally adjusting its pH to form a mixture having a pH of less than 10, wherein the depolymerized residue and water are in a weight ratio of at least 1:100; and c) blending the mixture with an adjuvant comprising a nitrogen source to form a culture medium having a pH of 6.8 to 10. In further aspects, methods of bioconverting a plastic polyester material are disclosed. The methods can include a) depolymerizing by heating the plastic polyester material in an aqueous mixture comprising an alcohol and having a pH of 10 or greater to obtain a depolymerized residue, b) mixing the depolymerized residue with water and optionally adjusting its pH to form a mixture having a pH of less than 10, wherein the depolymerized residue and water are in a weight ratio of at least 1:100, c) blending the mixture with an adjuvant comprising a nitrogen source to form a culture medium having an acidic, neutral, or basic pH, d) introducing an enzyme or an organism into the culture medium, and e) accumulating a product produced by the enzyme or the organism. The method can further comprise the step of sterilizing the mixture from step b) by heating at a temperature greater than 100° C. and at elevated pressure, preferably greater than 10 psi.

In some instances, the plastic material comprises a polyester, such as polyethylene terephthalate, polytrimethylene terephthalate, or a combination thereof. The depolymerized residue formed from the polyester containing plastic material can include one or more alcohols, one or more aldehydes, one or more carboxylic acids, or combinations thereof. In other instances, the plastic material comprises a polyurethane. The aqueous mixture used in depolymerizing the polyester or polyurethane plastic material can have a pH from 10 to 13 or from 12 to 13. The aqueous mixture can further comprise an emulsifying agent or an organic solvent, preferably an alcohol, DMSO, or a combination thereof. The mixture can be heated at a temperature of 300° C. or greater, such as from 300° C. to 500° C., or from 320° C. to 400° C.

In some aspects, methods of making a culture medium from a polystyrene containing plastic material comprising a) depolymerizing the polystyrene containing plastic material in a mixture comprising two or more of an oxidizing agent, styrene oxide, or acetone to obtain a depolymerized residue, and b) mixing the depolymerized residue with an adjuvant selected from a synthetic non-ionic biodegradable surfactant, a nitrogen source, a phosphate source, a carbohydrate source, a source of mineral, or a combination thereof to form a culture medium having a basic pH, are disclosed. In further aspects, methods of bioconverting a polystyrene containing plastic material comprising a) depolymerizing the polystyrene containing plastic material in a mixture comprising two or more of an oxidizing agent, styrene oxide, or acetone to obtain a depolymerized residue, b) mixing the depolymerized residue with an adjuvant selected from a surfactant, a nitrogen source, a phosphate source, a carbohydrate source, a source of mineral, or a combination thereof, c) introducing an enzyme or an organism into the culture medium, and d) accumulating a product produced by the enzyme or the organism, are disclosed. The polystyrene mixture can be an emulsion. In some instances, the depolymerized residue comprises styrene oxide.

In some examples, the culture media prepared from the polymeric materials described herein can comprise a pyrolyzed, depolymerized polyalkylene residue. For example, the culture media can comprise one or more branched C₆₋₃₆ alcohols, one or more branched C₆₋₃₆alkenes, and an adjuvant selected from a synthetic non-ionic biodegradable surfactant, a nitrogen source, a phosphate source, a carbohydrate source, a source of mineral, or a combination thereof. The pyrolyzed polyalkylene residue may make up at least 45 mole % or at least 55 mole % of carbon source in the culture medium. In other examples, the culture media can comprise a depolymerized residue selected from a depolymerized polyester residue, a depolymerized polyurethane residue, or a combination thereof, and an adjuvant selected from a biodegradable surfactant, a nitrogen source, a phosphate source, a carbohydrate source, a source of mineral, or a combination thereof, wherein the culture media have a pH of 9 or greater. When the depolymerized residue is a depolymerized polyester residue, the culture media can include one or more alcohols, one or more aldehydes, one or more carboxylic acids, or combinations thereof. In further examples, culture media comprising a depolymerized polystyrene residue comprising styrene oxide, and an adjuvant selected from a biodegradable surfactant, a nitrogen source, a phosphate source, a carbohydrate source, a source of mineral, or a combination thereof are also disclosed.

The culture media can further comprise a surfactant. The surfactant can include or consists essentially of a biodegradable surfactant, preferably a non-ionic surfactant, an anionic surfactant, or a combination thereof. The culture media can further comprise an adjuvant selected from water, acetate, lactose, glucose, fructose, maltose, ribose, a super optimal broth (SOB) media, a super optimal broth with catabolite repression (SOC) media, a nutrient broth, a nutrient agar, a minimal media, Luria-Bertani media, a sporulation broth, yeast extract, peptone, combinations thereof, or modifications thereof.

As described herein, the culture media described herein are suitable for producing a bioproduct from a microorganism including bacteria, algae, and fungi or from a gene, or an enzyme. In embodiments where an enzyme or microorganism is used, the enzyme or microorganism can express a fatty acid biosynthetic pathway; enhance metabolism of residues from the plastic material (such as polyalkylene residues, polyester or polyurethane residues, or polystyrene residues); increase flux of the plastic-derived compounds through fatty acid biosynthetic pathways; increase the uptake of plastic residues from the medium; or combinations thereof. In embodiments where an organism is used, the organism can comprise a gene, wherein the gene can encode an enzyme that enhances metabolism of plastic residues or encode essential enzymes to increase flux of plastic-derived compounds through fatty acid biosynthetic pathways. In further embodiments where an organism is used, the organism can comprise a gene, wherein the gene can encode a transport protein that increases the uptake of plastic residues from the medium.

In some embodiments, the microorganism can be a soil dwelling microorganism. For example, the microorganism can be a bacterium from the genus Bacillus, Pseudomonas, Streptomyces, Beijerinckia, or Rhodococcus. Specific examples of bacteria include Streptomyces coelicor, Bacillus subtilis, Bacillus lichenformis, Pseudomonas putida, Pseudomonas fluorescens, Beijerinckia indica, and Rhodococcus rhodochrous. In some embodiments, the microorganism can be a fungus from the genus Pichia, Rhodotorula, Candida, Aspergillus, Penicillium or Yarrowia. For example, the microorganism can be a lipid forming and storing (oleaginous) yeast. Specific examples of fungi include Pichia pastoris, Rhodotorula glutinis, Candida maltosa, Debaryomyces hansenii, Candida famata, Aspergillus oryzae, Penicillium roqueforti, and Yarrowia lipolytica. In some embodiments, the microorganism can be an alga, such as from the genus Chlorella. In some embodiments, the enzyme can be selected from a fatty alcohol dehydrogenase, a fatty alcohol oxidase, a fatty aldehyde dehydrogenase, or a combination thereof. Alternately, the microorganism can comprise said enzyme.

The product produced from the culture media can be a biopolymer, an enzyme, or a cellular metabolite. In some instances, a cellular metabolite such as a fatty acid can be collected from the culture media. Examples of fatty acids can include oleic acid, linoleic acid, palmitic acid, benzoic acid, stearic acid, palmitoleic acid, or a mixture thereof.

### BRIEF DESCRIPTION OF THE DRAWINGS

FIG. 1 shows carbon composition of PP oil after thermal depolymerization.

FIG. 2 shows growth of Y. lipolytica in OP4 medium. (FIG. 2A) Growth in OP4 medium versus a ‘surfactant control’ medium. Growth was measured as cell dry weight. The ‘surfactant control’ included all emulsifiers, nitrogen, phosphorous, and trace nutrient sources found in OP4 medium but did not include PP-derived compounds. (FIG. 2B) OP4 medium used during Y. lipolytica growth. The change in OP4 concentration was measured gravimetrically. Fatty alcohol consumption was measured by GC/MS. Mean±SD plotted for each data set.

FIG. 3 shows growth on OP4 medium components. Growth was measured gravimetrically. Statistical significance determined by ANOVA. Samples were considered significantly different if p<0.05. Treatments that share the same lower case or upper-case letter are not significantly different than one another.

FIG. 4 shows growth of Y. lipolytica on rich medium with and without 0.3% w/v cyclohexane. Growth was measured as optical density (600 nm). Statistical significance determined by Student's t-test. (**) indicates a significant difference (p<0.01) between treated samples and the untreated control.

FIG. 5 shows fatty acid production during growth in OP4 medium. Cells were imaged after 96 h. Magnification 400×. (FIG. 5A) left, OP4 medium; right and surfactant control. Note lipid inclusion bodies in yellow. (FIG. 5B) Mean Nile Red fluorescence quantified by digital image analysis.

FIG. 6 shows analysis of fatty acid production by Y. lipolytica during growth on OP4 medium vs surfactant control (FIG. 6A) total fatty acid (FA) yield. (FIG. 6B) distribution of FAs by carbon number. (FIG. 6C) distribution of saturated and unsaturated FAs (FIG. 6D) distribution of unsaturated FAs.

FIG. 7 shows effect of lipid-versus carbohydrate-containing media on fatty acid production. Cells were grown for 120 h prior to analysis.

FIG. 8 shows fatty acid yields of Y. lipolytica grown on OP5 medium.

FIG. 9 shows bioconversion of PTT by C. famata. At 48 h, the total C in substrate, cells and SCO=0.11 moles, or 45 percent of the Initial C input. At 120 h, measured C=54 percent of Initial C input. Also, single cell oil (SCO) formation at 48 h=12.5 percent of initial substrate C. EPS was measured at 120 h only. Inset: view of growth and product formation.

FIG. 10 shows polyester derived growth medium (PTT1) uptake by C. famata. Terephthalic acid (TPA) phase measured by LPLC-spectrophotometry; alcohol phase by GC-FIO.

FIG. 11 shows product formation by C. famata. Left, fatty acids at 48 h. Right, polysaccharides at 120 h. Analysis by GC/MS.

FIG. 12 shows PTT1 medium composition. After alkaline hydrolysis, the largest PTT derived molecules in PTT1 medium have a molecular weight (MW) less than 650. The most abundant fragments have a MW around 300. Analysis by ESI-MS.

FIG. 13 shows a control culture medium containing polystyrene and yeast extract.

FIG. 14 shows a polystyrene medium with Pseudomonas putia KT2440.

FIG. 15 shows a polystyrene medium with Candida famata.

FIG. 16 shows a polystyrene medium with Candida famata.

FIG. 17 shows a polyurethane medium with environmental isolates.

FIG. 18 is a graph showing growth of Yarrowia lipolytica, an oleaginous yeast in PTT2 (polyester derived) medium at pH 8.

FIG. 19 is a graph showing growth of two kinds of bacteria, Escherichia coli (Gram −) and Bacillus subtilis (Gram+) in PTT2 (polyester derived) medium at pH 8.

FIG. 20 is a graph showing growth of Candida famata in PTT2 (polyester derived) medium at pH 8. PTT media at a concentration of 1 g/L were inoculated using inoculum (OD600): A2-0.4 and A3-4.5.

FIG. 21 is a graph showing growth of Candida famata in PTT2 (polyester derived) medium at pH 8. PTT media at a concentration of 1 g/L (A3 PTT) and 5 g/L (A4 PTT) were inoculated using inoculum (OD600): A4-16 and A3-4.5.

FIG. 22 is an image showing accumulating metabolite in PTT1 solution during growth of C. famata. Image by brightfield microscopy, 1000× magnification after 25 h growth.

FIG. 23 is an image showing crystal of metabolite accumulating in solution. Magnification 10×. Note small round green yeast cells.

FIG. 24 is an image showing the same crystal as in FIG. 26, imaged with an epifluorescence microscope. Note the fluorescence using a rhodamine filter set. Magnification 10×.

FIGS. 25A-25D show media were prepared from two sources of polypropylene. (FIG. 25A) OP5 medium was prepared from virgin amorphous PP pellets. (FIG. 25B) PCOP5 medium was prepared from postconsumer dental floss packaging made of PP. (FIGS. 25C-25D) The carbon compositions of the corresponding PP oils was majority branched fatty alcohols. Otherwise, there was little similarity in composition.

FIGS. 26A-26C show growth in OP5 medium increased intracellular fatty acid content by Yarrowia lipolytica in comparison to growth in OP4 medium. FIG. 26A: biomass. FIG. 26B: fatty acid titer. FIG. 26C: fatty acid content.

FIGS. 27A-27B show fatty acid production dynamics during growth in OP5 medium. FIG. 27A: a transition from the oleaginous phase to the reserve lipid turnover phase at day 5 coincided with an increase in the accumulation of hexyldecanol, a residual unmetabolized compound derived from the growth medium. FIG. 27B: the dominant fatty acid produced by Y. lipolytica is oleic acid. The proportion of fatty acids in the recovered product was generally stable over the course of the experiment, although an increase in other products accelerated at day 5.

FIGS. 28A-28B show analysis of substrate uptake. FIG. 28A: Growth medium assimilation was measure by gravimetric analysis. FIG. 28B: Metabolism of carbon compounds detected in OP5 spent media after 120 h of Y. lipolytica growth. Analysis by GC/MS.

FIG. 29 shows comparison of biomass and fatty acid titers after growth on media prepared from each of the OP5 medium components. Biomass titers are significantly different if upper case letters are different (p<0.05). Fatty acid titers are significantly different if lower case letters are different (p<0.05).

FIG. 30 shows effect of C/N ratio on Y. lipolytica growth and fatty acid production. Biomass was greatest at C/N ratios of 20 and 40 (columns are marked with stars; same number of stars not significantly different than each other, p<0.05). Intracellular fatty acid content was highest at a C/N ratio of 80 (bars with same letters not significantly different, p<0.05). There was no significant impact of C/N ratio on fatty acid titers.

FIG. 31 shows effect of osmolarity on Y. lipolytica growth and fatty acid production. Cell growth was inhibited by NaCl (bars with same letters not significantly differ p<0.05). There was no significant impact of NaCl on fatty acid production or intracellular fatty acid content.

FIGS. 32A-32C show postconsumer plastic negatively impacts fatty acid production. FIG. 32A: Growth, total recovered product and fatty acid accumulation for cells grown on either OP5 or PCOP5 media. FIG. 32B: Product profile for cells grown in OP5 medium. FIG. 32C: Product profile for cells grown in PCOP5 medium.

### DETAILED DESCRIPTION

The materials, compounds, compositions, articles, and methods described herein may be understood more readily by reference to the following detailed description of specific aspects of the disclosed subject matter and the Examples included therein and to the Figures.

Before the present materials, compounds, compositions, articles, and methods are disclosed and described, it is to be understood that the aspects described below are not limited to specific synthetic methods or specific reagents, as such may, of course, vary. It is also to be understood that the terminology used herein is for the purpose of describing particular aspects only and, unless a particular term is specifically defined herein, is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an organism” includes two or more of such organisms, reference to “the plastic material” includes mixtures of two or more such plastic materials, and the like.

The term “gene” is used broadly to refer to any segment of nucleic acid associated with a biological function. Genes include coding sequences and/or the regulatory sequences required for their expression. For example, gene refers to a nucleic acid fragment that expresses mRNA, functional RNA, or a specific protein, including its regulatory sequences. Genes also include non-expressed DNA segments that, for example, form recognition sequences for other proteins.

Genes can be obtained from a variety of sources, including cloning from a source of interest or synthesizing from known or predicted sequence information, and may include sequences designed to have desired parameters. In addition, a “gene” or a “recombinant gene” refers to a nucleic acid molecule comprising an open reading frame and including at least one exon and (optionally) an intron sequence. The term “intron” refers to a DNA sequence present in a given gene which is not translated into protein and is generally found between exons.

“Naturally occurring,” “native” or “wild type” is used to describe an object that can be found in nature as distinct from being artificially produced. For example, a nucleotide sequence present in an organism (including a virus), which can be isolated from a source in nature and which has not been intentionally modified in the laboratory, is naturally occurring. Furthermore, “wild-type” refers to the normal gene, or organism found in nature without any known mutation.

As used herein, the term “recombinant nucleic acid,” e.g., “recombinant DNA sequence or segment” refers to a nucleic acid, e.g., to DNA, that has been derived or isolated from any appropriate cellular source, that may be subsequently chemically altered in vitro, so that its sequence is not naturally occurring, or corresponds to naturally occurring sequences that are not positioned as they would be positioned in a genome that has not been transformed with exogenous DNA. An example of preselected DNA “derived” from a source would be a DNA sequence that is identified as a useful fragment within a given organism, and which is then chemically synthesized in essentially pure form. An example of such DNA “isolated” from a source would be a useful DNA sequence that is excised or removed from said source by chemical means, e.g., by the use of restriction endonucleases, so that it can be further manipulated, e.g., amplified, for use in the invention, by the methodology of genetic engineering.

The term “non-biodegradable” is used broadly to refer to “non-biodegradable polymer plastic” or “non-biodegradable polymer containing material” made from at least one plastic material, such as plastic sheet, tube, rod, profile, shape, massive block etc., which contains at least one polymer that does not undergo significant change in its chemical structure from the action of naturally-occurring microorganisms under general environmental conditions resulting in loss of some properties that may vary as measured. ASTM subcommittee D20.96 has developed standards in the area of biodegradable plastics. The plastic may further contain other substances or additives, such as plasticizers, mineral or organic fillers, antioxidants, slip agents and heat stabilizers. More preferably, the non-biodegradable polymer plastic is a manufactured product like packaging, fiber material such as carpets, agricultural films, disposable items or the like. It can be mixed with other wastes such as organic wastes or chemical components (soap, surfactants etc). Non-biodegradable plastic polymeric materials are well-known and used in the field of polymer recycling. The specification recites a list of suitable non-biodegradable polymeric materials, such as those used to make carpet fibers. In the methods disclosed herein, a non-biodegradable polymeric plastic material can be depolymerized and/or dispersed and form a bioavailable polymeric mixture.

Compositions and Methods

Compositions and methods of processing a polymeric material are disclosed herein. In particular embodiments, methods of reducing pollution from postconsumer wastes derived from a polymeric material are disclosed. The methods can include depolymerizing the polymeric material and optionally bioconverting the depolymerized polymeric material, the product of which can be used as feedstocks for other bioconversion processes to make biochemicals and other value-added biological products. The polymeric material can be a plastic material. The terms “plastic” and “plastic material” as used herein refers to any organic polymer that is moldable and extrudable and can assume an infinite variety of shapes and forms according to its use or application. In some examples, the plastic materials are synthetic polymers derived from hydrocarbons. In further examples, the plastic materials are resistant to biodegradation and cannot undergo efficient microbial catabolism because of their sterically hindered structure, hydrophobicity, and high molecular weight. In some cases, the plastic material consists essentially of a thermoplastic polymer (polymers that soften when exposed to heat and return to their original state when cooled at room temperature). In other cases, however, the plastic material comprises the thermoplastic polymer resin mixed with various additives to improve performance and longevity. These additives include inorganic fillers such as carbon and silica that reinforce the material, plasticizers to render the material pliable, thermal and ultraviolet stabilizers, flame retardants, and colorings. Other common additives include antioxidants (such as organophosphate antioxidants), slip agents (such as heavy metal-based slip agents), antistatic components, impact modifiers, colorants, acid scavengers, X-ray fluorescent agents, radiation opaque fillers, surface modifiers, melt stabilizers, nucleating agents including clarifying agents, flame retardants, organic fillers and other polymers, reinforcing agents, and heat stabilizers.

The polymeric material useful in the methods disclosed herein can include natural or synthetic homopolymers or copolymers. The homopolymers or copolymers can be linear, branched, or cross-linked. In some examples, the polymeric material includes polyvinyl chloride, polyalkylene, polystyrene, polyurethane, polyester, nylon, polyimide, polyacrylate, polyalkylene terephthalate, polyalkylene naphthalate, polyolefin, polyacrylonitrile, rayon, polyetherimide, polyamide-imide, polyvinylalcohol, polyvinyl acetate, polycarbonate, ABS copolymer, polytetrafluoroethylene, polyacrylic, polypeptide, protein, cellulose, wool, or a combination thereof. In some examples, the polymeric material can include polyethylene, polypropylene, polybutylene, polyethylene terephthalate, polyethylene naphthalate, polylactic acid, nylon (polyamide) cellulose acetate, polycaprolactam, polylaurolactam, polyacrylamide, polystyrene, a copolymer thereof, or a combination thereof.

In some examples, the polymeric material includes nylon. The nylon can be derived from nylon 6, nylon 11, nylon 12, nylon 46, nylon 66, nylon 69, nylon 77, nylon 91, nylon 610, nylon 612, nylon 6/66, nylon 6/66/610, or combinations thereof.

In some examples, the polymeric material includes a polyester. The polyester can be derived from a polyalkylene terephthalate, such as polyethylene terephthalate fibers (PET), polybutylene terephthalate fibers (PBT), polytrimethylene terephthalate fibers (PTT), or from other aromatic polyesters.

In some examples, the polymeric material includes a polyalkylene which may include high and/or density polyalkylene containing plastic material. The polyalkylene can have the general structure CₙH₂ₙ₊₂ and includes polyethylene, polypropylene, or combinations thereof. In some examples, the polymeric material includes polypropylene. The polymeric material can include 50% by weight or greater polypropylene, such as 55% by weight or greater, 60% by weight or greater, 65% by weight or greater, 70% by weight or greater, 75% by weight or greater, 80% by weight or greater, 85% by weight or greater, 90% by weight or greater, 95% by weight or greater, or up to 100% by weight polypropylene. The polymeric material can include from 50% up to 100% by weight polypropylene, such as from 60% to 100% by weight, from 75% to 100% by weight, from 50% to 98% by weight, from 60% to 98% by weight, from 75% to 95% by weight, or from 60% up to 90% by weight polypropylene.

In some examples, the polymeric material includes a styrene, α-methylstyrene, o-chlorostyrene, or vinyltoluene. In some embodiments, the polymeric material can include styrene. The styrene can be in an amount of 5% or greater by weight, based on the weight of the polymeric material. For example, the styrene can be in an amount of 7% or greater, 10% or greater, 20% or greater, 30% or greater, 40% or greater, 50% or greater, 60% or greater, or 70% or greater by weight, based on the weight of the polymeric material. In some embodiments, the styrene can be in an amount of 100% or less, 95% or less, 85% or less, 75% or less, 70% or less, 65% or less, 60% or less, 55% or less, 50% or less, 45% or less, 40% or less, 35% or less, 30% or less, 25% or less, 20% or less, 15% or less, or 10% or less, by weight, based on the weight of the polymeric material. In some embodiments, styrene can be in an amount of from 50% up to 100% by weight, such as from 60% to 100% by weight, from 75% to 100% by weight, from 50% to 98% by weight, from 60% to 98% by weight, from 75% to 95% by weight, or from 60% up to 90% by weight, based on the weight of the polymeric material. In some embodiments, the polymeric material comprises polystyrene. In some embodiments, the polymeric material consists essentially of polystyrene.

In some examples, the polymeric material includes polyurethane. The polyurethane can be derived from one or more of an aromatic diisocyanate, an aliphatic diisocyanate, a cycloaliphatic diisocyanate, or a combination thereof. For example, the polyurethane can be derived from an aromatic isocyanate such as toluene diisocyanate, naphthalene 1,5-diisocyanate, naphthalene 1,4-diisocyanate, diphenylmethane 4,4′-diisocyanate, diphenylmethane 2,4′-diisocyanate and mixtures of 4,4′-diphenylmethane diisocyanate with the 2,4′ isomer, hydrogenated xylylene diisocyanate, 4,4′-diphenyl-dimethylmethane diisocyanate, di- and tetraalkyl-diphenylmethane diisocyanates, 4,4′-dibenzyl diisocyanate, 1,3-phenylene diisocyanate, triphenylmethane triisocyanate, 1,4-phenylene diisocyanate, or combinations thereof. In other examples, the polyurethane can be derived from a cycloaliphatic diisocyanate such as 4,4′-dicyclohexylmethane diisocyanate, 1-isocyanatomethyl-3-isocyanato-1,5,5-trimethyl-cyclohexane (isophorone diisocyanate), cyclohexane 1,4-diisocyanate, isophorone diisocyanate, xylylene diisocyanate, 1-methyl-2,4-diisocyanato-cyclohexane, m- or p-tetramethylxylene diisocyanate, dimer fatty acid diisocyanate, or combinations thereof. In further examples, the polyurethane can be derived from an aliphatic diisocyanate such as tetramethylene diisocyanate, hexamethylene diisocyanate, tetramethoxybutane 1,4-diisocyanate, butane 1,4-diisocyanate, hexane 1,6-diisocyanate, 1,6-diisocyanato-2,2,4-trimethylhexane, 1,6-diisocyanato-2,4,4-trimethylhexane, lysine diisocyanate, 1,12-dodecane diisocyanate, or combinations thereof. The polymeric material can include 50% by weight or greater polyurethane, such as 55% by weight or greater, 60% by weight or greater, 65% by weight or greater, 70% by weight or greater, 75% by weight or greater, 80% by weight or greater, 85% by weight or greater, 90% by weight or greater, 95% by weight or greater, or up to 100% by weight polyurethane. The polymeric material can include from 50% up to 100% by weight polypropylene, such as from 60% to 100% by weight, from 75% to 100% by weight, from 50% to 98% by weight, from 60% to 98% by weight, from 75% to 95% by weight, or from 60% up to 90% by weight polyurethane. In some embodiments, the polymeric material can include a homopolymer or copolymer derived from a monomer selected from an amino acid, a dicarboxylic acid, an aminocarboxylic acid, an amine, a diamine, and combinations thereof. For example, the homopolymer or copolymer can be derived from monomers selected from adipic acid, terephthalic acid, phthalic acid, isophthalic acid, aminoundecanoic acid, aminolauric acid, sebacic acid, dodecanoic acid, caprolactam, laurolactam, 6-aminohexanoic acid, hexamethylene amine, and combinations thereof.

The polymer (including the homopolymer or copolymer) present in the polymeric material can have a weight average molecular weight of 5,000 Da or greater (e.g., 7,000 Da or greater, 8,000 Da or greater, 10,000 Da or greater, 12,000 Da or greater, 13,000 Da or greater, 14,000 Da or greater, 15,000 Da or greater, 17,000 Da or greater, 20,000 Da or greater, 25,000 Da or greater, 35,000 Da or greater, 50,000 Da or greater, 75,000 Da or greater, 100,000 Da or greater, 150,000 Da or greater, 200,000 Da or greater, or 250,000 Da or greater). In some cases, the polymer (including the homopolymer or copolymer) present in the polymeric material can have a weight average molecular weight of 250,000 Da or less (e.g., 200,000 Da or less, 150,000 Da or less, 100,000 Da or less, 75,000 Da or less, 50,000 Da or less, 40,000 Da or less, 35,000 Da or less, 30,000 Da or less, 25,000 Da or less, 20,000 Da or less, 18,000 Da or less, 16,000 Da or less, 15,000 Da or less, 14,000 Da or less, 12,000 Da or less, 10,000 Da or less, 9,000 Da or less, 8,000 Da or less, 7,000 Da or less, 6,000 Da or less, or 5,000 Da or less). In some cases, the polymer (including the homopolymer or copolymer) present in the polymeric material can have a weight average molecular weight of from 5,000 Da to 250,000 Da, from 5,000 Da to 100,000 Da, from 5,000 Da to 50,000 Da, from 5,000 Da to 25,000 Da, from 10,000 Da to 200,000 Da, from 10,000 Da to 100,000 Da, from 10,000 Da to 50,000 Da, or from 10,000 Da to 25,000 Da.

In some embodiments, the polymeric material can be a plastic article, including thermoplastic articles. According, in some aspects of the present disclosure, methods of reducing plastic pollution, particularly, reducing the amount of postconsumer waste plastic entering the environment are disclosed. In some examples, the plastic article can include a fibrous material. For example, the plastic article can include natural or synthetic organic fibers of cellulose acetate, polyalkylene such as polypropylene or polyethylene, polystyrene, polyurethane, polyester such as polyethylene terephthalate, synthetic polyamide such as polycaprolactam, polylaurolactam, or polyhexamethylene adipamide, or combinations thereof. Other suitable examples of plastic articles that can be processed using the methods described herein include plastic films, foams, cast or uncast plastic packaging materials, plastic containers, packaging materials, credit cards, electronic components, construction materials, data storage devices, automotive and aircraft parts, floor coverings, adhesives, coatings, insulating foams, toys, appliances, telephones, machine screws, gear wheels, power tool casings, apparels and fabrics, carpet fibers, industrial waste plastic, and pipes. In some examples, the polymeric material can be a waste carpet material.

Solvents for processing the polymeric material are described herein. In some embodiments, the solvent can depolymerize, dissolve, and/or disperse the polymeric material. “Disperse” and “dispersing”, as used herein, refer to the distribution of a particulate phase or phases, solid particles, or droplets, of the polymeric material throughout a liquid continuous phase. “Depolymerize” and “depolymerizing” as used herein, refer to degradation of a polymer into monomeric units, oligomeric units, polymeric units, and/or complete decomposition of the polymer. Depolymerization can occur by any suitable process known in the art, such as by hydrolysis, chain scission, or oxidation. Suitable solvents for processing the polymeric material can include an acid, a base, an oil, a non-polar organic solvent, an oxidizing solvent, an emulsifying solvent, and combinations thereof. In some examples, the solvent can include an acid having a boiling point of 150° C. or less. For example, the solvent can include inorganic acids such as hydrochloric acid, short chain organic acids such as formic acid, acetic acid, and combinations thereof. In some examples, the solvent can include a base. For example, the solvent can be an aqueous mixture comprising a base, such as sodium oxide, such that the aqueous mixture has a pH of 10 or greater. In some embodiments, the solvent can include a catalyst. In some embodiments, the solvent can include an oxidizing agent, such as potassium permanganate.

In some examples, the solvent can be an oil. “Oil”, as used herein, can include fats, fatty substances, waxes, wax-like substances, and mixtures thereof. Suitable fats and fatty substances can include fatty alcohols (such as lauryl, myristyl, stearyl, cetyl or cetostearyl alcohol), fatty acids and derivatives, including but not limited to fatty acid esters, fatty acid glycerides (mono-, di- and tri-glycerides), and hydrogenated fats. Suitable waxes and wax-like materials include natural or synthetic waxes, hydrocarbons, and normal waxes. As used herein, a wax-like material is defined as any material which is normally solid at room temperature and has a melting point of from about 30 to 300° C. Specific examples of oils that can be used to process the polymeric material include paraffin oil, olive oil, polyisobutene oil, hydrogenated polyisobutene oil, polydecene oil, polyisoprene oil, polyisopropene oil, myristic acid, palmitic acid, oleic acid, linoleic acid, capric acid, lauric acid, neodecanoic acid, vegetable oils such as peanut oil, corn oil, and sesame oil, hydrogenated cottonseed oil, hydrogenated castor oil, hydrogenated oils available under the trade name Sterotex®, stearic acid, cocoa butter, stearyl alcohol, beeswax, glycowax, castor wax, carnauba wax, paraffins, candelilla wax, and mixtures thereof. In some embodiments, the oil can include a terpene. The terpene can, in some embodiments, increase the dispersing properties of the polymeric material. Suitable terpenes can include monoterpenes. In some examples, the terpene can be derived from essential oils from plants.

In some embodiments, a surfactant can be used in the methods of processing the polymeric materials disclosed herein. The surfactant can be combined with the polymeric material and/or the depolymerized residue. The surfactants can, in some embodiments, lower surface tension and thereby increase the emulsifying, foaming, dispersing, spreading, and wetting properties of the polymeric material. Suitable surfactants may be anionic, cationic, amphoteric, or nonionic surfactants. In some embodiments, the surfactant is biodegradable. The term “biodegradable” as used herein refers to a material or substance wherein decomposition is effected under conditions normally present in a culture medium. The biodegradable surfactants can undergo physical dissolution and/or chemical degradation and/or broken down by microorganisms, or spontaneously break down over a relatively short time (within 2-15 months) when exposed to environmental conditions commonly found in nature.

Suitable anionic surfactants include those containing carboxylate, sulfonate and sulfate ions. Examples of anionic surfactants include sodium, potassium, ammonium of long chain alkyl sulfonates and alkyl aryl sulfonates such as sodium dodecylbenzene sulfonate, dialkyl sodium sulfosuccinates, and alkyl sulfates. Cationic surfactants include, but are not limited to, quaternary ammonium compounds such as polyoxyethylene and coconut amine. Examples of nonionic surfactants include ethylene glycol monostearate, propylene glycol myristate, glyceryl monostearate, glyceryl stearate, polyglyceryl-4-oleate, sorbitan acylate, sucrose acylate, PEG-150 laurate, PEG-400 monolaurate, polyoxyethylene monolaurate, polysorbates such as TWEEN® 20 (polysorbate 20) and TWEEN® 80 (polysorbate 20), polyoxyethylene octylphenylether, PEG-1000 cetyl ether, polyoxyethylene tridecyl ether, polypropylene glycol butyl ether, emulsifying wax, glyceryl monooleate, polyoxyethylene castor oil derivatives, benzyl alcohol, benzyl benzoate, cyclodextrins, stearoyl monoisopropanolamide, polyoxyethylene hydrogenated tallow amide, and combinations thereof. Examples of amphoteric surfactants include sodium N-dodecyl beta-alanine, sodium N-lauryl beta-iminodipropionate, myristoamphoacetate, lauryl betaine and lauryl sulfobetaine. In some embodiments, the methods utilize both anionic and non-ionic surfactants. In some examples, the surfactant is selected from sodium lauryl sulfate (SLS), sodium dodecyl sulfate (SDS), sodium octyl sulfate (SOS), sodium bis-(2-ethylthioxyl)-sulfosuccinate, TWEEN© such as TWEEN® 20 (polysorbate 20) and TWEEN® 80 (polysorbate 80), fatty acids such as C₈-C₂₂ and other fatty acids, C₈-C₂₂ fatty alcohols, polyols, and combinations thereof can be used. In some embodiments, a synthetic nonionic biodegradable surfactant is used in the methods of processing the polymeric materials disclosed herein. Examples of synthetic nonionic biodegradable surfactants include polysorbate surfactants such as TWEEN® 20 (polysorbate 20) and TWEEN® 80 (polysorbate 80).

In some embodiments, a surfactant (particularly glycolipids such as rhamnolipids) is not used in the methods of processing the polymeric materials disclosed herein.

Culture Media

As described herein, methods of reducing plastic pollution from postconsumer wastes are disclosed. In some aspects of reducing plastic pollution, the methods comprise attributing to the plastic waste economic value, i.e. to valorize it, so the waste is not readily discarded. Particularly, the plastic waste can be used as feedstocks for bioconversion processes to make biochemicals and other value-added biological products. In some embodiments, the polymeric material, preferably a plastic waste material, can be used to prepare culture media. The culture media can contain one or more carbon sources derived from the polymeric materials described herein. In some embodiments, the culture media can contain one or more carbon sources, wherein at least one of the one or more carbon sources can be derived from a plastic material such as a waste carpet material.

In some embodiments, the one or more carbon sources can include the depolymerized residue (as the carbon source) obtained from the polymeric material. in some examples, the depolymerized residue can be derived from a polyalkylene polymeric material, a polystyrene polymeric material, a polyurethane polymeric material, or a polyester polymeric material. The depolymerized residue can include a polymer, monomer, oligomer, or combinations thereof, which are derived from the polymeric material. For example, the depolymerized residue (as the carbon source) can include an amino acid, a dicarboxylic acid, an aminocarboxylic acid, a lactam, an amine, a diamine, a polyamine, an alkene, an alkane, a polyalkylene, a ketone, an alcohol, an aldehyde, an oligomer or polymer thereof, or a combination thereof. Specific examples of the depolymerized residues (as the carbon source) can include adipic acid, terephthalic acid, phthalic acid, isopthalic acid, aminoundecanoic acid, aminolauric acid, sebacic acid, dodecanoic acid, caprolactam, laurolactam, 6-aminohexanoic acid, hexamethylene amine, and combinations thereof.

In some embodiments, the culture media can include a depolymerized residue (as the carbon source) derived from pyrolysis of a polyalkylene. Pyrolysis of a polyalkylene, such as polypropylene, can include one or more depolymerized residues selected from alkenes, alcohols, alkanes, alkynes, aldehydes, ketones, among other constituents. Particularly, pyrolysis of a polyalkylene can yield a mixture of branched chain alkenes and branched chain alcohols as the major components. In some examples, the depolymerized residue comprises one or more of branched chain fatty alcohols, branched chain alkenes, or a combination thereof. The culture media can include a depolymerized residue selected from one or more of branched chain C₆₋₃₆ alcohols, branched chain C₆₋₃₆ alkenes, or a combination thereof. Branched chain alkenes that may be present include 2,4-dimethylhept-1-ene, 2,4,6,8-tetramethyl-1-undecene, 1,4-dimethyl-decene, or combinations thereof. Branched chain fatty alcohols that may be present include 2-hexyl-1-decanol, 2-methyl-1-decanol, or combinations thereof.

The one or more branched chain fatty alcohols can be present in an amount of 30% by weight or greater (e.g., 35% by weight or greater, 40% by weight or greater, 45% by weight or greater, 50% by weight or greater, 55% by weight or greater, 60% by weight or greater, 65% by weight or greater, or 70% by weight or greater), based on the total weight of the depolymerized residue. In some embodiments, the one or more branched chain fatty alcohols can be present in an amount from 30% up to 90% by weight (e.g., from 30% to 75% by weight, from 40% to 75% by weight, from 40% to 60% by weight, from 45% to 75% by weight, or from 45% to 60 by weight), based on the total weight of the depolymerized residue. The one or more branched chain fatty alcohols can be present in an amount of greater than 0% by weight or greater (e.g., 2% by weight or greater, 4% by weight or greater, 5% by weight or greater, 8% by weight or greater, 10% by weight or greater, 12% by weight or greater, 15% by weight or greater, 18% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, or 70% by weight or greater), based on the total weight of the carbon source in the culture medium. In some embodiments, the one or more branched chain fatty alcohols can be present in an amount from greater than 0% up to 90% by weight (e.g., from 5% to 75% by weight, from 10% to 75% by weight, from 10% to 60% by weight, from 15% to 75% by weight, or from 15% to 60 by weight), based on the total weight of the carbon source in the culture medium.

The one or more branched chain fatty alkenes can be present in an amount of 10% by weight or greater (e.g., 12% by weight or greater, 15% by weight or greater, 18% by weight or greater, 20% by weight or greater, 22% by weight or greater, 25% by weight or greater, 30% by weight or greater, or 35% by weight or greater), based on the total weight of the depolymerized residue. In some embodiments, the one or more branched chain alkenes can be present in an amount from 10% up to 50% by weight (e.g., from 10% to 45% by weight, from 15% to 45% by weight, from 15% to 35% by weight, from 20% to 45% by weight, or from 20% to 35 by weight), based on the total weight of the depolymerized residue. The one or more branched chain fatty alkenes can be present in an amount of greater than 0% by weight or greater (e.g., 2% by weight or greater, 4% by weight or greater, 5% by weight or greater, 8% by weight or greater, 10% by weight or greater, 12% by weight or greater, 15% by weight or greater, 18% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, or 70% by weight or greater), based on the total weight of the carbon source in the culture medium. In some embodiments, the one or more branched chain fatty alkenes can be present in an amount from greater than 0% up to 90% by weight (e.g., from 5% to 75% by weight, from 10% to 75% by weight, from 10% to 60% by weight, from 15% to 75% by weight, or from 15% to 60 by weight), based on the total weight of the carbon source in the culture medium.

Both the branched chain fatty alcohols and branched chain alkenes can be present in an amount of 50% by weight or greater (e.g., 55% by weight or greater, 60% by weight or greater, 65% by weight or greater, 70% by weight or greater, 75% by weight or greater, 80% by weight or greater, 85% by weight or greater, or 90% by weight or greater), based on the total weight of the depolymerized residue. In some embodiments, the branched chain fatty alcohols and branched chain alkenes can be present in an amount from 50% up to 95% by weight (e.g., from 50% to 90% by weight, from 50% to 85% by weight, from 50% to 80% by weight, from 60% to 95% by weight, from 60% to 85% by weight, from 65% to 95% by weight, or from 65% to 80 by weight), based on the total weight of the depolymerized residue. The branched chain fatty alcohols and branched chain alkenes can be present in an amount of greater than 0% by weight or greater (e.g., 2% by weight or greater, 4% by weight or greater, 5% by weight or greater, 8% by weight or greater, 10% by weight or greater, 12% by weight or greater, 15% by weight or greater, 18% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, or 70% by weight or greater), based on the total weight of the carbon source in the culture medium. In some embodiments, the branched chain fatty alcohols and branched chain alkenes can be present in an amount from greater than 0% up to 90% by weight (e.g., from 5% to 75% by weight, from 10% to 75% by weight, from 10% to 60% by weight, from 15% to 75% by weight, or from 15% to 60 by weight), based on the total weight of the carbon source in the culture medium.

The depolymerized residue (such as derived from a polyalkylene, polyester, polystyrene, or polyurethane) can be present in an amount of greater than 0% by weight or greater (e.g., 2% by weight or greater, 4% by weight or greater, 5% by weight or greater, 8% by weight or greater, 10% by weight or greater, 12% by weight or greater, 15% by weight or greater, 18% by weight or greater, 20% by weight or greater, 25% by weight or greater, 30% by weight or greater, 35% by weight or greater, 40% by weight or greater, 45% by weight or greater, 50% by weight or greater, 55% by weight or greater, 60% by weight or greater, 65% by weight or greater, 70% by weight or greater, 75% by weight or greater, 80% by weight or greater, 85% by weight or greater, 90% by weight or greater, or 95% by weight or greater), based on the total weight of the carbon source in the culture medium. In some embodiments, the depolymerized residue (such as derived from a polyalkylene, polyester, polystyrene, or polyurethane) can be present in an amount from greater than 0% up to 100% by weight (e.g., from 5% to 95% by weight, from 25% to 95% by weight, from 50% to 95% by weight, from 5% to 75% by weight, from 10% to 75% by weight, from 10% to 60% by weight, from 15% to 75% by weight, or from 15% to 60 by weight), based on the total weight of the carbon source in the culture medium.

In some embodiments, the culture medium comprises a ratio of carbon to nitrogen of from 1:10 to 10:1, from 1:5 to 10:1, from 1:1 to 10:1, from 2:1 to 10:1, or from 2:1 to 4:1.

The culture media can also contain a suitable adjuvant. The adjuvant can be selected from water, acetate, lactose, glucose, fructose, maltose, ribose, a super optimal broth (SOB) media, a super optimal broth with catabolite repression (SOC) media, a nutrient broth, a nutrient agar, a minimal media, Luria-Bertani media, a sporulation broth, yeast extract, peptone, and combinations or modifications thereof. One or more of the adjuvants present in the culture media can provide an additional carbon source. For example, the surfactant, yeast extract, or glucose can serve as an additional carbon source in the culture media. In some embodiments, the culture media can include a carbon source derived from a polymeric material and an adjuvant selected from water, minimal salt media such as M9, and combinations thereof.

In some examples, the culture media can have an acidic, neutral, or basic pH. For example, the culture media can have a pH of 8 or greater, such as from 8 to 12, from 8 to 11, from 8 to 10, from 8.5 to 11, from 8.5 to 10, or from 8.5 to 9.5. In other examples, the culture media can have an acidic to neutral pH. For example, the depolymerized residue can be mixed with water and its pH adjusted to form a mixture having a pH of less than 10, followed by blending the mixture with an adjuvant comprising a nitrogen source to form a culture medium having an acidic to neutral pH of 7 or less. In these embodiments, the culture media can have a pH of 7 or less, such as from 5.5 to 7, from 6 to 7, or from 6.2 to 6.8. In some examples, the culture media can have a pH from 6.8 to 10, from 6.8 to 9.5, or from 6.8 to 8.

Methods

Methods of processing the polymeric materials described herein are disclosed. As described herein, the polymeric material can be used to form a culture medium. Accordingly, methods of preparing a culture medium from the polymeric materials described herein are disclosed.

As described herein, the polymeric material can be derived from a post-consumer waste. The polymeric material may be provided in a suitable form, such as in the form of flakes, chips, pellets, etc. The culture media can be prepared using any of the methods described herein. In some embodiments, methods of preparing a culture medium can include (a) depolymerizing and/or dispersing the polymeric material to obtain a depolymerized and/or dispersed residue, and (b) combining the depolymerized and/or dispersed residue with one or more adjuvants to form the culture medium. In certain embodiments, the residues obtained in step (a) include depolymerized residues. In certain embodiments, the residues obtained in step (a) include dispersed residues. In certain embodiments, the residues obtained in step (a) include depolymerized and dispersed residues. In some examples, the method can include the step of melting the polymeric material prior to step (a) depolymerizing and/or dispersing the polymeric material to obtain a depolymerized and/or dispersed residue. For example, a polymeric material containing nylon 66 can be heated to 260° C., the melting point of nylon 66, prior to depolymerizing and/or dispersing the nylon polymer.

Depolymerizing can include pyrolyzing the polymeric material to obtain a depolymerized residue. The terms “pyrolyzing” and “pyrolysis” as used herein are given their conventional meaning in the art and are used to refer to the transformation of a compound, e.g., the polymeric material, into one or more other thermodynamically stable substances, e.g., volatile organic compounds, gases, and coke, by heat alone, which may take place with or without the use of a catalyst. The temperature at which the polymeric material pyrolyzes varies based on the specific polymeric material used in the methods. For example, polypropylene can pyrolyze by heating to a temperature of 350° C. or greater, such as from 400° C. to 600° C., or from 400° C. to 500° C. In general, the method can include depolymerizing the polymeric material, such as a polyalkylene containing plastic material, by pyrolyzing a neat or heterologous mixture of the material at a temperature of 350° C. or greater (for example, 375° C. or greater, 400° C. or greater, 450° C. or greater, 500° C. or greater, 550° C. or greater, 700° C. or less, 650° C. or less, 600° C. or less, 550° C. or less, 350° C. to 700° C., 350° C. to 650° C., or 400° C. to 600° C.), to obtain a depolymerized residue. The term “neat” as used herein refers to the condition of solvent being absent or excluded from a reaction mixture. Alternately, the term “neat” can also refer to conditions of a reaction wherein the solvent of the reaction is one of the reactants. The “heterologous” mixture refers to a mixture with a non-uniform composition. In particular, the “heterologous” mixture can include a solvent being present in the reaction mixture.

In other embodiments, depolymerizing can include heating the polymeric material in an alkaline, aqueous mixture to obtain a depolymerized residue. The alkaline, aqueous mixture can have a pH of 10 or greater, such as from 10 to 14, from 10 to 13, from 10 to 12, from 11 to 13, from 11 to 12, or from 12 to 13. The aqueous mixture can further comprise an emulsifying organic solvent, such as an alcohol (e.g., ethanol), DMSO, or a combination thereof. The temperature at which the polymeric material depolymerizes in the alkaline, aqueous mixture varies based on the specific polymeric material used in the methods. For example, polyester can depolymerize by heating to a temperature of 300° C. or greater, such as from 300° C. to 500° C., or from 320° C. to 400° C. In general, the method can include depolymerizing the polymeric material, such as a polyester or polyurethane containing plastic material, by heating in an aqueous mixture at a temperature of 300° C. or greater (for example, 325° C. or greater, 350° C. or greater, 375° C. or greater, 400° C. or greater, 425° C. or greater, 450° C. or greater, 475° C. or greater, 500° C. or greater, 550° C. or less, 525° C. or less, 500° C. or less, 300° C. to 550° C., 350° C. to 550° C., or 320° C. to 500° C.), to obtain a depolymerized residue.

In further embodiments, depolymerizing the polymeric material can include contacting the polymeric material with an emulsifying agent and/or an oxidizing agent to form a mixture. For example, polystyrene can be chemically depolymerized and then solubilized using compounds that emulsify it. In some embodiments, the methods can include depolymerizing polystyrene in a mixture of styrene oxide and acetone. Alternately, an oxidizing agent such as potassium permanganate can be used to depolymerize polystyrene, thereby forming styrene oxide and/or styrene oxide like molecules.

In other embodiments, depolymerizing and/or dispersing the polymeric material can include contacting the polymeric material with a solvent to form a mixture. The solvent can include an organic acid, inorganic acid having a boiling point of 150° C. or less, a base, a non-polar organic solvent, an oil, or combinations thereof. In some embodiments, depolymerizing and/or dispersing the polymeric material can further include heating the mixture containing the polymeric material and the solvent. In some examples, the mixture can be heated up to the boiling point of the solvent. For example, the mixture can be heated to 50° C. or greater (for example, 75° C. or greater, 100° C. or greater, 150° C. or greater, 200° C. or greater, 300° C. or greater, 300° C. or less, 250° C. or less, 200° C. or less, 150° C. or less, 50° C. to 300° C., 50° C. to 250° C., or 50° C. to 200° C.).

The amount of solvent used during depolymerization and/or dispersion can be determined by one skilled in the art. In some embodiments, the solvent can be in an amount to facilitate optimal blending and/or dispersal of the polymeric material with the solvent. In some examples, the volume ratio of the solvent to the polymeric material can be from 10:1 or greater. For example, the volume ratio of the solvent to the polymeric material can be from 10:1 to 1000:1, such as 10:1 to 100:1 or 50:1 to 100:1.

The mixture comprising the depolymerized and/or dispersed residues can be further processed prior to combining with the adjuvant. In some embodiments, the depolymerized and/or dispersed residues can be processed (for example, purified) prior to combining with the adjuvant. Processing the depolymerized and/or dispersed residue can include separating (such as by centrifuging) insoluble polymeric particles from the residues, separating soluble components from the solid depolymerized residues, neutralizing the mixture comprising the residues, washing the residues, removing the one or more solvents from the residues, and combinations thereof. In some examples, the depolymerized and/or dispersed residues can be processed by centrifuging, filtering, neutralizing, evaporating, distilling (including vacuum distillation), rinsing, and combinations thereof.

The depolymerized and/or dispersed residues can be combined with one or more adjuvants described herein to form the culture medium. For example, the depolymerized and/or dispersed residues can be combined with water or minimal media. In some embodiments, the pH of the mixture comprising the depolymerized and/or dispersed residues and the adjuvant can be adjusted. In general, the pH can be adjusted using for example sodium hydroxide or hydrochloric acid, to an acidic, neutral, or basic pH such as pH of 6.7 or greater, from 6.7 to 10, from 6.8 to 10, or from 6.2 to 6.8.

In some examples, the method of making a culture medium from the polymeric material can include (a) heating the polymeric material with a solvent to depolymerize and/or disperse the polymeric material and form a mixture, (b) processing the mixture to form a resin, and (c) combining the resin with one or more adjuvants to form a culture medium. In some embodiments, the method can further include melting the polymeric material prior to step (a) heating the polymeric material with a solvent.

In other examples, the method of making a culture medium from the polymeric material can include (a) pyrolyzing the polymeric material to form a depolymerized residue, and (b) combining the depolymerized residue with one or more adjuvants to form the culture medium.

The culture media disclosed herein can be used for culturing a microorganism. In some embodiments, the microorganism can include a bacterium, an alga, or a fungus. In some examples, the microorganism can be a soil dwelling microorganism. In some embodiments, the microorganism can be a bacterium of the genus Bacillus, Pseudomonas, Streptomyces, Beijerinckia, or Rhodococcus. For example, the bacterium can be selected from Streptomyces coelicor, Bacillus subtilis, Bacillus lichenformis, Pseudomonas putida, Pseudomonas fluorescens, Beijerinckia indica, Rhodococcus rhodochrous, and combinations thereof. In some embodiments, the microorganism can be a fungus of the genus Pichia, Rhodotorula, Candida, Aspergillus, Penicillium or Yarrowia. For example, the fungus can be a lipid forming and storing yeast. Specific examples of fungi include Pichia pastoris, Rhodotorula glutinis, Candida maltosa, Debaryomyces hansenii, Candida famata, Aspergillus oryzae, Penicillium roqueforti, and Yarrowia lipolytica. In some embodiments, the microorganism can be an alga. Specific examples can include an alga from the genus Chlorella. In some examples, the organism is not Pseudomonas (such as Pseudomonas aeruginosa or Pseudomonas oleovorans), Acinetobacter (such as Acinetobacter calcoaceticus); or Burkholderia cepacia.

The culture media can also be used to produce a bioproduct, such as a biopolymer, an enzyme, or a cellular metabolite. In some embodiments, the culture media can be used to produce a biopolymer. The biopolymer can be any desirable biopolymer including for example, a polyester (such as polyhydroxyalkanoate) or a polysaccharide. In some examples, the biopolymer can be polyhydroxybutyrate, polyhydroxyvalerate, a copolymer of poly(hydroxybutyrate-co-hydroxyvalerate), poly(3-hydroxybutyrate-co-4-hydroxybutyrate), or a copolymer of hydroxyl terminated polyhydroxybutyrate.

In some embodiments, the culture media can be used to produce a cellular metabolite, such as a lipid or peptide. The lipid can be any desirable lipid depending on the host cell/enzyme/gene used, including for example, lipids derived from oleic acid, linoleic acid, palmitic acid, benzoic acid, stearic acid, palmitoleic acid, or a combination thereof. The peptide can be any desirable peptide depending on the host cell/enzyme/gene used, including for example, dipeptides and tripeptides.

The method for producing the bioproduct can include introducing a host cell (organism) or enzyme that expresses the bioproduct's biosynthetic pathway into a culture medium as disclosed herein. In embodiments where an enzyme or host cell (organism) is used, the enzyme or host cell can express a fatty acid biosynthetic pathway; enhance metabolism of residues from the plastic material (such as polyalkylene residues, polyester or polyurethane residues, or polystyrene residues); increase flux of the plastic-derived compounds through fatty acid biosynthetic pathways; increase the uptake of plastic residues from the medium; or combinations thereof. The host cell can be any one of the microorganisms disclosed herein. For example, the host cell can be selected from a fungus, a bacterium, or an alga. In some embodiments, the host cell or enzyme can contain one or more recombinant sequences that encodes the bioproduct's biosynthetic pathway. In embodiments where an organism is used, the organism can comprise a gene, the gene encoding an enzyme that enhances metabolism of plastic residues or encoding essential enzymes to increase flux of plastic-derived compounds through fatty acid biosynthetic pathways. In further embodiments where an organism is used, the organism can comprise a gene, the gene encoding a transport protein that increases the uptake of plastic residues from the medium.

The method for producing the bioproduct can include synthesizing and accumulating the bioproduct in the host cell by culturing the host cell. Suitable conditions for culturing the host cell can be readily identified by a person skilled in the art. For example, suitable conditions can include an appropriate medium that contains an appropriate carbon source as described herein and growing the host cell for a time sufficient to obtain expression of the required sequence (i.e., production of gene product) from the genes of the bioproduct's biosynthetic pathway, to produce the bioproduct. The bioproduct can then be recovered from the host cell. Recovering the bioproduct can include separating the bioproduct from the host cell, for example where the bioproduct is not extruded or secreted by action of the host cell during or after its production within the host cell.

In some embodiments, the method for producing the biopolymer can include introducing a host cell that expresses the desired biopolymer's biosynthetic pathway into the culture media, accumulating the biopolymer in the host cell by culturing the host cell, and recovering the biopolymer produced by the host cell. In some embodiments, the method for producing the enzyme can include introducing a host cell that expresses the desired enzyme's biosynthetic pathway into the culture media, accumulating the enzyme in the host cell by culturing the host cell, and recovering the enzyme produced by the host cell. In some embodiments, the method for producing the cellular metabolite can include introducing a host cell that expresses the desired metabolite's biosynthetic pathway into the culture media, accumulating the cellular metabolite in the host cell by culturing the host cell, and recovering the cellular metabolite produced by the host cell.

Methods for bioconverting a polymeric material to produce a cellular metabolite, such as a lipid, are disclosed. In some embodiments, the method can include pyrolyzing the polymeric material, such as a polyalkylene containing plastic material to obtain a depolymerized residue, optionally mixing the depolymerized residue with an adjuvant selected from a surfactant, a nitrogen source, a phosphate source, a carbohydrate source, a source of mineral, or a combination thereof, introducing an enzyme expressing a fatty acid biosynthetic pathway or an organism that expresses a fatty acid biosynthetic pathway into the culture medium, and accumulating at least one fatty acid produced by the enzyme or the organism.

As described herein, the plastic material (such as a post-consumer waste) can include additives. The additives may present challenges when bioconverting the plastic material. In some embodiments, the methods for bioconverting a polymeric material to produce a cellular metabolite can further include identifying, separating, and/or reducing the additive content of the polymeric material prior to or after depolymerization of the polymeric material.

Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the scope of the disclosure. Unless indicated otherwise, parts are parts by weight, temperature is in ° C. or is at ambient temperature, and pressure is at or near atmospheric.

### Example: Microbial Bioconversion of Thermally Depolymerized Polypropylene by Yarrowia lipolytica for Fatty Acid Production

Plastic production and waste generation will continue to rise as nations worldwide grow economically. This example details a pyrolysis-based bioconversion process for polypropylene (PP) to produce value-added fatty acids (FAs). PP pellets were depolymerized by pyrolysis, generating an oil that consisted of mainly branched chain fatty alcohols and alkenes. The oil was mixed with biodegradable surfactants and trace nutrients and mechanically homogenized. The resulting medium, OP4, was used for fermentation by Yarrowia lipolytica strain 78-003. Y. lipolytica assimilated >80% of the substrate over 312 hr, including 86% of the fatty alcohols. Y. lipolytica produced up to 492 mg L⁻¹ lipids, compared to 216 mg L⁻¹ during growth in surfactant-based control medium. C18 compounds, including oleic acid, linoleic acid, and stearic acid were the predominant products, followed by C16 compounds palmitic and palmitoleic acids. Two percent of the products were C 20 compounds. The majority of the products were unsaturated FAs. Growth on hydrophobic substrates (OP4 medium, hexadecane) was compared with growth on hydrophilic substrates (glucose, starch). The resulting FA profiles revealed an absence of short-chain fatty acids during growth on hydrophobic media, findings consistent with ex novo FA biosynthesis. Overall, FA profiles by Y. lipolytica during growth in OP4 medium were similar to FA profiles while growing on natural substrates. The process described here offers an alternative approach to managing post-consumer plastic waste.

Introduction: Plastic pollution is an environmental threat that continues to expand in scope. In 2015, more than 320 million tons of plastic products were produced worldwide, up from 180 million tons in 2000. With an average Compound Annual Growth Rate (CAGR) of 8.6% since 1950 (Geyer et al. 2017), combined with the strong correlation between global plastic waste generation and gross national income per capita (Geyer et al. 2017), plastic production and waste generation are likely to continue to rise as developing nations worldwide continue to grow economically. Of concern, if historic trends continue, a significant fraction of plastic can be expected to reach the environment: of the estimated 6.3 billion tons of plastic waste generated since 1950, 12% was incinerated and 9% was recycled, leaving approximately 4.9 billion tons of plastic accumulating in landfills and marine and soil ecosystems (Geyer et al. 2017).

One facet of a solution to plastic pollution is to reduce the amount of postconsumer plastic entering the environment. An important element in accomplishing this goal is to give postconsumer plastic waste economic value, i.e. to valorize it, so it is not readily discarded. Standard plastic recycling techniques generally yield materials that are of lower quality than the initial product, resulting in “downcycling”, or a loss of value (Mantia 2004). In contrast, a biological approach to recycling plastic waste can potentially be economically sustainable: plastic waste can be used as feedstocks for bioconversion processes to make biochemicals and other value-added biological products, resulting in “upcycling”. The rationale for this concept has two parts: first, several kinds of postconsumer plastics can be depolymerized into mixtures of labile molecules (4) and second, microbes can synthesize triacylglycerols, organic acids, enzymes and other biological products as they grow on plastic-derived media. This approach can be used to make products that justify the costs associated with recycling plastic waste.

Polypropylene (PP) comprises nearly 25 percent of the global plastics market share (Geyer et al. 2017), yet to date there are no reported microbial bioconversion processes for PP. A challenge for microbial metabolism of PP is its low bioavailability, resulting from its high molecular weight, hydrophobicity and a molecular structure that resists enzymatic attack (Arutchelvi et al. 2008; Jeyakumar et al. 2013; Longo et al. 2011). It was hypothesized that a depolymerization pretreatment to generate PP-derived oligomers could aid in the production of a growth medium suitable for microbial bioconversion. Pyrolysis was used to depolymerize and oxidize PP and then biodegradable surfactants used to disperse the resulting products in an aqueous medium suitable for microbial growth. The PP-derived growth medium was used for cultivating the oleaginous yeast Yarrowia lipolytica. Y. lipolytica grows on diverse substrates and produces a wide variety of intracellular and extracellular products, including fatty acids, organic acids, extracellular enzymes and other proteins (Abghari and Chen 2014; Ageitos et al. 2011; Aggelis 2002; Beopoulos et al. 2008; Bialy et al. 2011; Fickers et al. 2005; Rakicka et al. 2015; Xu et al. Xue et al. 2013; Zhang et al. 2014). In this example, Y. lipolytica was cultivated in a PP-derived medium in order to produce FAs.

Methods

Polypropylene Growth Medium Preparation: OP4 medium, a polypropylene-derived medium, was prepared by pyrolyzing virgin amorphous polypropylene (Mw=14,000) in 3 g batches at 540° C. in 125 ml borosilicate flat-bottomed flasks for 190 min. The resulting pyrolysis oil (at 15 g L⁻¹) was combined with additional compounds as follows: 5.4 g L⁻¹ Tween-80@, 4.5 g L⁻¹ oleic acid, 1.25 g L⁻¹ (NH₄)2SO₄, 2.5 g L⁻¹ KH₂PO₄, and 0.830 g L⁻¹ MgSO₄ 7H₂O. The mixture was emulsified with a hand-held food-grade homogenizer and autoclaved for 70 min at 121° C. and 15 psi.

Chemicals and Reagents: Virgin polypropylene pellets and oleic acid were purchased from Sigma Aldrich (Millipore Sigma, USA). Tween 80@, chloroform, methanol, cyclohexane, hexane, and all culturing compounds used were of research grade and purchased from Fisher Chemicals (Fisher Scientific, USA).

Cultures and Growth Conditions: Yarrowia lipolytica strain 78-003 (ATCC strain 46483) was the sole strain used in this example. Glycerol frozen stocks of Y. lipolytica were prepared (1 ml, OD₆₀₀=20) and were stored at −80° C. For all experiments, a frozen aliquot was thawed and added into a 250 ml Erlenmeyer flask containing 50 ml of 5% glucose medium (consisting of 50 g L⁻¹ glucose and 3 g L⁻¹ yeast extract). Each inoculated flask was incubated overnight at 30° C. with shaking at 200 rpm. After incubation, 1 ml samples were withdrawn and centrifuged at 10,000 rpm for 2 min, and the pellets were washed twice with 50 mM phosphate buffered saline (PBS) solution. Y. lipolytica was cultured using 500 ml Erlenmeyer flasks containing 50 ml OP4 medium; the flasks were inoculated with an overnight culture of Y. lipolytica at an inoculation density of 0.3 (OD₆₀₀ ml⁻¹) and incubated at 30° C. with shaking at 200 rpm.

Several versions of OP4 were prepared to evaluate the impact of medium components on lipid and biomass yields. ‘Nitrogen and trace minerals only’ medium consisted of: 1.25 g L⁻¹ (NH₄)2SO₄, 1.25 g L⁻¹ yeast extract, 2.5 g L⁻¹ KH₂PO₄, and 0.830 g L⁻¹ MgSO₄ 7H₂O. ‘Surfactant only’ medium was comprised of 5.4 g L⁻¹ Tween- 80@ and 4.5 g L⁻¹ oleic acid, without trace minerals or nitrogen. ‘PP only’ medium, which was OP4 medium without any surfactants, was comprised of 12 g L⁻¹ pyrolyzed polypropylene, 1.25 g L⁻¹ (NH₄)2SO₄, 1.25 g L⁻¹ yeast extract, 2.5 g L⁻¹ KH₂PO₄, and 0.830 g L⁻¹ MgSO₄ 7H₂O. ‘Surfactant control’ medium was comprised of 5.4 g L⁻¹ Tween- 80@, 4.5 g L⁻¹ oleic acid, 0.25 g L⁻¹ (NH₄)2SO₄, 1.25 g L⁻¹ yeast extract, 2.5 g L⁻¹ KH₂PO₄, and 0.830 g L⁻¹ MgSO₄ 7H₂O.

The hexadecane medium used for FA profile experiments consisted of: 5% v/v hexadecane, 5 g L⁻¹ yeast nitrogen broth (w/amino acids), 0.5 g L⁻¹ KH₂PO₄, and 0.25 g L⁻¹ Mg₂SO₄.

Starch medium used for FA profile experiments consisted of: 50 g L⁻¹ hydrolyzed starch, 2 g L⁻¹ yeast nitrogen broth (w/amino acids), 0.5 g L⁻¹ KH₂PO₄, and 0.25 g L⁻¹ Mg₂SO₄. The medium consisted of: 5.4 g L⁻¹ Tween- 80®, 1.25 g L⁻¹ (NH₄)2SO₄, 2.5 g L⁻¹ KH₂PO₄, and 0.830 g L⁻¹ MgSO₄. Glucose (5%) medium used for FA profile experiments consisted of: 50 g L⁻¹ glucose and 3 g L⁻¹ yeast extract.

Microscopy for Imaging Oil Droplet Production: A modified Nile Red staining method (Rostron and Lawrence 2017) was utilized to stain Y. lipolytica intracellular neutral lipids. Sample aliquots (1 ml) of post-fermentation culture were withdrawn and centrifuged, and pellets were washed twice with 0.9% NaCl. Pellets were suspended in 1.0 ml 10 mM PBS with 0.15M KCl and the 00600 was adjusted to 10. Technical grade Nile Red powder (Millipore Sigma, USA) was dissolved in acetone to make a 10 mg mL⁻¹ solution and 10 μL was added to 1.0 ml cell samples (suspended in 50 mM PBS and calibrated to an OD of ˜5.0) in dark conditions, and samples were vortexed and incubated at room temperature (in dark conditions) for approximately 15 min. A Zeiss LSM 510 confocal microscope (Zeiss, USA) was used to visualize stained cells. 10 μL of sample were used for confocal analysis. Cells were excited at 488 nm, and emissions were imaged at 543 nm.

Intracellular Lipid Quantification: A modified Bligh and Dyer extraction (Bligh and Dyer 1959) was used to extract lipids from yeast samples. Post-fermentation OP4 culture was withdrawn and aliquoted into pre-weighed 50 ml conical tubes, and tubes were centrifuged, and pellets washed twice with 0.9% NaCl. Pellets were lyophilized overnight using a BT3.3 EL Lyophilizer Tabletop (SP Scientific, USA), weighed, and suspended in a 2:1 v/v chloroform: methanol mixture (5 ml per 50 mg cell dry weight) and sonicated using a Sonic Dismembrator (Fisher Scientific, USA) at 20 kHz, 20% amplitude with pulsing (40 s on, 20 s off for a total working time of 20 min). The chloroform layer was taken and dried under a nitrogen stream. Dried lipids were weighed and derivatized for GC/MS analysis via base-catalyzed esterification with 2.5 ml sodium methoxide (0.1 M) (Milanesio et al. 2013). The reaction was quenched using 200 μL sulfuric acid (>95%), and 2.5 ml hexane was added to each sample, which was then vortexed and centrifuged (5 min at 5000 rpm). 1.5 ml from the top hexane layer was withdrawn for GC/MS analysis.

GC/MS Analysis of Lipid Profile: The FA profile was characterized with an Agilent 7890A gas chromatograph (GC) attached to a 5977A mass spectrometer detector and equipped with an Agilent J&W HP-5 ms UI capillary column (30 mm×0.25 mm×0.25 m). 1 μL samples were injected via an Agilent 7693 Automatic Liquid Sampler in splitless mode with an inlet temperature of 275° C., using helium as the carrier gas at a flow rate of 1 ml min·1. GC oven temperature was held at 60° C. for 1 min, and ramped to 100° C. (rate: 25° C. min·1; hold 1 min). The oven temperature was then increased to 200° C. (rate: 25° C. min⁻¹; hold 1 min). The oven temperature is then increased to 220° C. (rate: S ° C. min·1; hold 7 min) and then increased to an ending temperature of 300° C. (rate: 25° C. min·1; hold 2 min). A C8-C24 FAME analytical standard was used during sample analyses as an external standard (Sigma Aldrich, USA).

Pyrolysis oil characterization via GC/MS: 3 g pyrolysis oil was dissolved in 200 ml chloroform (Sigma Aldrich, USA) and 1.5 μL aliquots were analyzed via GC/MS. A GC method (Guzik et al. 2014) was used to characterize the polypropylene pyrolysis oil. 1 μL of the diluted pyrolysis oil was injected via automatic liquid sampler at an inlet temperature of 275° C. and a 2:1 split ratio. The oven method was 30° C. for 1 min, then ramping to 100° C. (rate: 7.5° C. min), then ramping to 300° C. (rate 10° C. min⁻¹, hold 2 min).

Substrate Degradation Analysis: Substrate degradation analysis was done both gravimetrically and via GC/MS. 10 ml aliquots of OP4 medium pre- and post-fermentation were taken for analysis. Media was centrifuged (10 min at 7000 rpm) and 5 ml of media transferred to pre-weighed conical tubes and wet weight of media documented. Samples were lyophilized and weighed, and the dry cell weight was suspended in a 1:1:1 v/v mixture of hexane, chloroform and deionized water (15 ml) and vortexed until sample was fully dissolved. Afterward, 1.5 ml of the top hexane layer was withdrawn and used for GC/MS analyses.

Growth Measurements: One ml of Y. lipolytica overnight culture was pelleted (10,000 rpm, 10 min) and pellets were washed twice with SO mM PBS, and then resuspended in 1 ml 50 mM PBS to reach a final OD₆₀₀ of 15. The inoculum was used to inoculate all experiments involving growing cells at the initial optical densities indicated in the text. At set timepoints, 1 ml aliquots were withdrawn and OD₆₀₀ measurements were taken using an Eppendorf 6131 Biophotometer (Eppendorf, USA).

For gravimetric analysis of growth, 50 ml aliquots were withdrawn, centrifuged at 10,000 rpm for 10 min, the supernatant discarded, and cell pellets were washed twice with 50 mM PBS and lyophilized overnight before being weighed.

Cyclohexane toxicity assay: Yeast malt broth (10 gL⁻¹ dextrose, 5 g L⁻¹ malt extract, 3 g L⁻¹ peptone, and 5 g L⁻¹ yeast extract) was used to cultivate Y. lipolytica cells. 1 ml aliquots of overnight culture (inoculation density: 0.30 [600 nm]) were used to inoculate 50 ml of either yeast malt broth only or yeast malt broth with 0.23% w/v cyclohexane. One ml samples were withdrawn at select timepoints, and growth was measured spectrophotometrically (600 nm).

Results

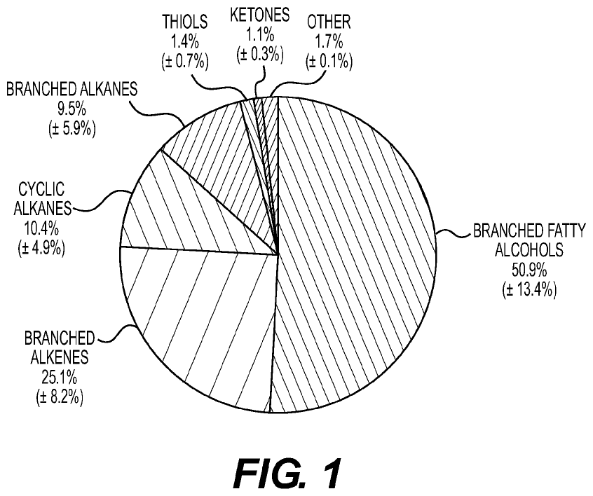

Polypropylene thermal depolymerization: Pyrolysis of virgin amorphous polypropylene (PP) pellets generated an oil-like fluid that turned waxy when cooled rapidly. GC/MS analysis of the PP oil identified approximately 18 different compounds across the batches that were prepared. More than 80% of PP oil was branched chain compounds, with branched fatty alcohols (50.9%) and branched alkenes (25.1%) making up approximately 75% of all available carbon sources (FIG. 1). The branched alkenes detected were all CₙH₂ₙ compounds, with the most abundant compound being 2,4-dimethylhept-1-ene ˜14%), followed by 2,4,6,8-tetramethyl-1-undecene (˜6%) and 1,4-dimethyl-decene (˜5%). The branched fatty alcohols detected were CₙH₂ₙ₊₂ compounds, with 2-hexyl-1-decanol ˜41%) being the predominant compound, followed by 2-methyl-1-decanol (˜10%).

Analyzing Y. lipolytica growth and activity in OP4 medium: comparisons with a ‘surfactant control’ medium: 48.9 percent of the total carbon in OP4 medium, on a moles C basis, was derived from the biodegradable surfactant. The remainder of the carbon in the medium was found in the PP oil, with trace amounts derived from the supplemented yeast extract. To determine the extent to which the PP oil in OP4 contributed to Y. lipolytica growth and to formation of biochemical products, a series of experiments were conducted comparing the activity of Y. lipolytica grown in OP4 medium versus a ‘surfactant control’ medium. The ‘surfactant control’ was identical in composition to OP4 medium except that it contained no PP oil.

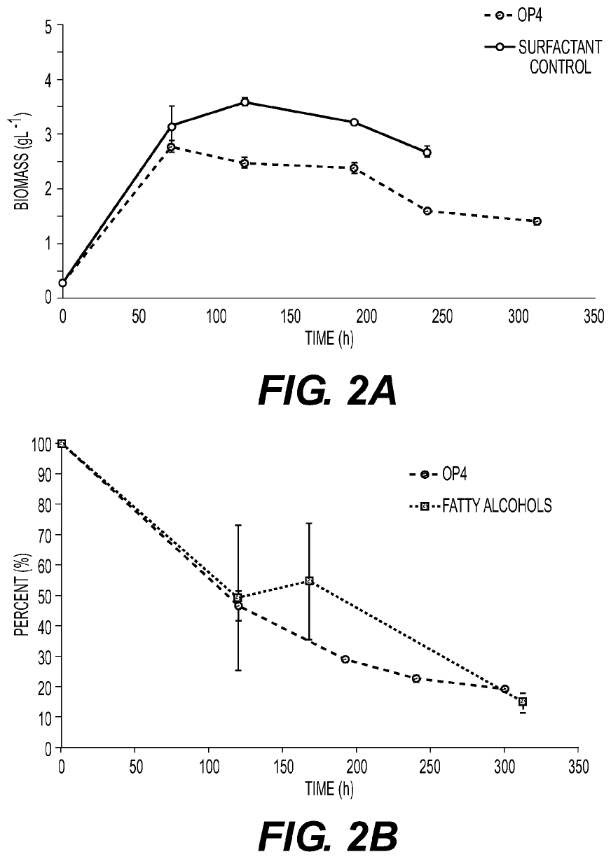

Measuring Y. lipolytica growth: To determine the extent that PP oil contributed to Y. lipolytica growth, cell growth was measured gravimetrically. The analysis indicated an average of 27% less biomass when cells were grown on OP4 medium (FIG. 2a). Biomass accumulation peaked after 72 h. The biomass remained at 2.4 g L⁻¹ or greater through 192 h.

OP4 medium uptake during growth: To determine the extent of OP4 medium uptake during growth, the mass of medium remaining in solution was measured. More than 80 percent of OP4 medium was taken up after 13 days (312 h) (FIG. 2b). OP4 medium contains 51 percent fatty alcohols which originated from PP and are produced during pyrolysis. To determine whether medium components originating from PP were taken up by Y. lipolytica, the change in fatty alcohol concentration in the medium was analyzed via GC/MS (FIG. 2b). Approximately 51% of fatty alcohols in OP4 medium were taken up by Y. lipolytica by 120 h, with 86% of the fatty alcohols used by 312 h. The uptake of total FAs and fatty alcohols occurred in a similar fashion over the course of experiments.

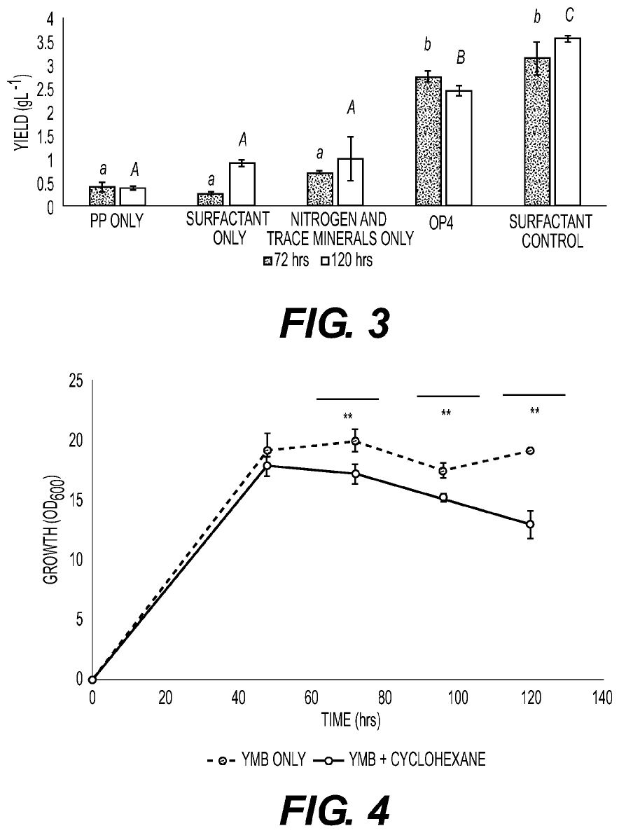

Impact of OP4 components on growth and FA production: OP4 medium contains several components that contribute to the overall growth of Y. lipolytica. To determine the effect of individual components of the medium on cell growth, a series of comparisons were made (FIG. 3). Yeast extract was used as a supplemental nitrogen source and contributed approximately 25 percent of the maximum measured biomass. A comparison of the ‘surfactant only’ and ‘surfactant control’ treatments confirmed that supplemental nitrogen and salts were necessary to increase the yield. Comparing the ‘PP only’ and ‘OP4’ treatments indicated that the presence of surfactant in the medium increased the yield more than six-fold. On the other hand, comparisons of ‘OP4’ and ‘surfactant only’ treatments or ‘PP only’ and nitrogen and trace minerals only’ treatments determined that PP oil in the growth medium inhibited Y. lipolytica growth. Although PP oil in OP4 medium inhibited growth, it significantly increased the FA yield (Table 1).

TABLE 1
Intracellular lipid yields by Y. lipolytica
during growth in OP4 medium or its components.

| | Yield (mg/L) | Significance |
|---|---|---|
| OP4 | 526.3 ± 12.5 | a |
| Surfactant-based control | 215.9 ± 20.2 | b |
| Surfactant only [symbol] | 117.6 ± 9.3 | c |
| Nitrogen + trace minerals [symbol] | 7.3 ± 1.9 | d |
| PP + Nitrogen + trace minerals [symbol] | 2.8 ± 0.4 | d |

a Significance determined by ANOVA. Samples were considered significantly different if p < 0.05.
b Treatments that share the same lower case letter are not significantly different than one another. [symbol]
indicates data missing or illegible when filed

Effect of cycloalkanes on Y. lipolytica growth: Cyclic alkanes have been reported elsewhere to be poor growth substrates for Y. lipolytica and other industrial yeasts (Beam and Perry 1974; Das and Chandran 2011; Mauersberger et al. 1996). OP4 contains 0.15±0.08 percent (w/v) cyclic alkanes. To determine whether cyclic alkanes inhibited growth of Y. lipolytica at the concentration that they are found in OP4 medium, growth in a rich medium with or without 0.23 percent (w/v) cyclohexane added (FIG. 4) were compared. Cyclohexane was selected as a representative cyclic alkane. The presence of cyclohexane reduced cell growth relative to control cells by 72 hours, a difference which persisted through 120 hours. The extent of growth inhibition ranged from 6 percent to 32 percent over the course of the experiment.

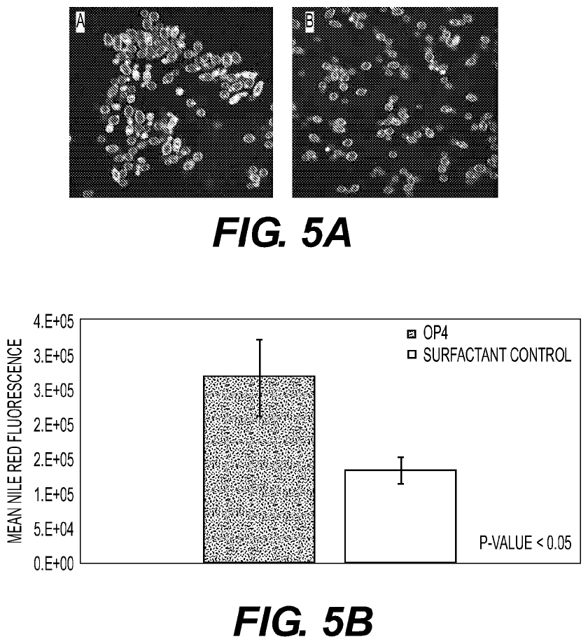

Microscopy analysis of lipid accumulation: Lipid accumulation by Y. lipolytica cells grown in OP4 medium or ‘surfactant control’ medium was analyzed by Nile Red staining and confocal microscopy followed by quantitative image analysis. Differences in the cellular lipid content were visibly noticeable in compositely stained cells (FIG. 5a). Cells grown in OP4 medium tended to aggregate compared to those grown in surfactant-based medium. The mean fluorescence for cells grown in OP4 medium was nearly twice that of cells growing in surfactant-based medium (p<0.05), indicating greater lipid accumulation when cells were grown in OP4 medium (FIG. 5b).

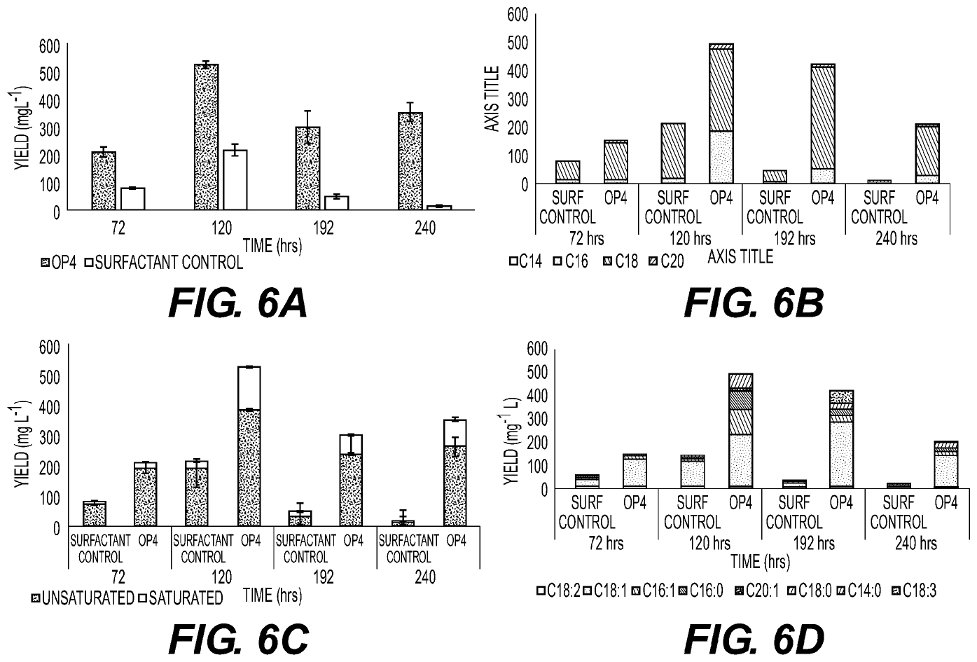

Fatty acid yields during growth in OP4 medium versus surfactant control: To determine the extent that PP contributed to the production of fatty acids by Y. lipolytica, a comparison of FA production between cells grown in OP4 medium versus surfactant-based medium was conducted. Lipid yields were determined via GC/MS analysis. FA yields were significantly higher when Y. lipolytica grew on OP4 medium compared to the ‘surfactant control’ medium (FIG. 6a). This was true at each of the measured timepoints over the course of experiments. Y. lipolytica generated most of its lipid bulk between 72 and 120 h. The bulk of the FAs produced were C 18, followed by C 16, with small amounts of C 20 and trace amounts of C 14 FAs at 240 h (FIG. 6b). The bulk of the FAs produced were unsaturated; there was no significant difference in the proportion of unsaturated to saturated FAs between the ‘surfactant control’ and the OP4 medium (FIG. 6c). However, there was a significant increase in the percentage of saturated FAs produced as the experiment progressed: between 72 h and 240 hr the fraction of saturated FAs increased from 10±1 percent to 35±8 percent (p<0.05). The majority of FAs produced were monounsaturated C18:1 FAs (FIG. 6d).

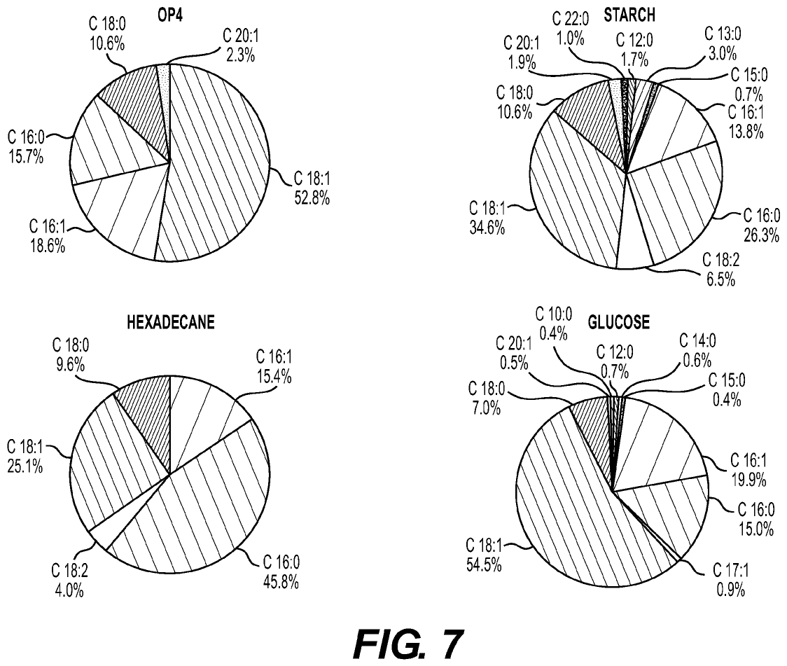

Effect of lipids or carbohydrates on FA production: Oleaginous yeast are often grown on carbohydrates and produce FAs by de novo biosynthesis; in contrast, OP4 medium contains hydrocarbons derived from PP depolymerization and from biodegradable surfactants, likely inducing ex novo FA biosynthesis. To help understand how the composition of OP4 medium affected FA production, Y. lipolytica was grown in media containing lipids or carbohydrates as the carbon source (FIG. 7). The substrates that were examined were: glucose (5%), starch (2%), hexadecane (5%) and OP4 medium (1.5% PP-derived compounds). Hexadecane was selected as a representative hydrophobic substrate found in OP4 medium. The C 18 FA oleic acid was the dominant FA produced by Y. lipolytica during growth in each medium except hexadecane. C 16 and C 18 FA distribution was consistent among cells grown on both carbohydrate-based substrates and OP4, with deviation occurring on hexadecane-grown cells. Palmitic or palmitoleic acid, C 16 FAs, were the second most abundant, followed by C 18 stearic acid. In hexadecane-containing medium, saturated palmitic acid was the main FA produced. Only 5 FAs were produced when Y. lipolytica was grown in OP4 or hexadecane-containing medium. In contrast, the FA profiles of Y. lipolytica grown on glucose and starch were more complex, with 10 different types of FAs produced, including the shorter chain FAs myristic, dodecanoic, pentadecanoic, and tridecanoic acids.

To determine whether the PP content of OP4 influenced the type of FA products produced, the FA profiles from growth in OP4 medium versus in the ‘surfactant control’ medium were compared (Table 2). Several features were evident. First, with the exception of 192 h, palmitoleic acid was a greater fraction of the FAs produced in OP4 medium than the ‘surfactant control’. Conversely, at each timepoint except 120 h, the palmitic acid fraction was larger in the ‘surfactant control’. Second, there was a spike in the fraction of oleic acid in the OP4 medium with respect to the ‘surfactant control’ at 192 h. Lastly, very long chain fatty acids (≥C 20) were only found in cells grown in OP4 medium.

TABLE 2
Fatty acid profiles of Y. lipolytica grown
in OP4 medium or surfactant control medium.

| | |
|---|---|
| 72 hrs | 120 hrs |

| | Surfactant | | Surfactant | |
|---|---|---|---|---|
| Name | Control | OP4 | Control | OP4 |
| C 16:0 | 9.6 ± 0.9 | 6.4 ± 0.1 | 10.2 ± 0.8 | 15.7 ± 0.3 |
| C 16:1 | 4.1 ± 0.3 | 6.6 ± 0.4 | 5.5 ± 0.6 | 18.6 ± 0.2 |
| C 18:0 | 1.7 ± 0.1 | 2.2 ± 0.4 | 11.0 ± 0.4 | 10.6 ± 0.7 |
| C 18:1 | 67.4 ± 1.3 | 68.2 ± 4.5 | 51.8 ± 4.8 | 52.8 ± 1.1 |
| C 18:2 | 17.2 ± 1.3 | 15.0 ± 3.4 | 21.5 ± 2.7 | n.d. |
| C 20:1 | n.d. | 0.74 ± 0.1 | n.d. | 2.3 ± 0.1 |
| Other^{d} | n.d. | 0.95 ± 0.1 | n.d. | n.d. |

| | 192 hrs | | 240 hrs | |
|---|---|---|---|---|
| | Surfactant | | Surfactant | |
| Name | Control | OP4 | Control | OP4 |
| C 14:0 | n.d. | n.d. | n.d. | 0.8 ± 0.2 |
| C 16:0 | 21.3 ± 0.4 | 5.8 ± 0.5 | 21.8 ± 2.1 | 4.8 ± 1.0 |
| C 16:1 | 3.6 ± 1.9 | 6.6 ± 0.7 | 4.8 ± 1.3 | 21.6 ± 0.6 |
| C 18:0 | 17.9 ± 0.4 | 4.1 ± 0.4 | 20.3 ± 2.7 | 20.1 ± 0.7 |
| C 18:1 | 50.4 ± 11.0 | 79.1 ± 15.1 | 45.0 ± 9.0 | 44.5 ± 6.6 |
| C 18:2 | 6.7 ± 2.3 | 3.3 ± 2.8 | 10.0 ± 2.1 | 7.3 ± 0.5 |
| C 18:3 | n.d. | 0.1 ± 0.01 | n.d. | n.d. |
| C 20:1 | n.d. | 0.9 ± 0.1 | n.d. | 0.7 ± 0.1 |

a P Values are percent of total FAs present at the indicated time. Mean ± SD.
b At each time point, Student's t test was used to evaluate whether there was a significant difference in the amount of each compound produced. Values that are significantly greater (p < 0.05) are in bold font.
c n.d.; not detected.
^{d}compounds include heptadecanoic and tridecanoic acids.

### DISCUSSION

If plastic waste can be used in bioconversion processes, then an incentive will exist to keep it out of the environment. In this example, it was demonstrated that compounds generated from PP pyrolysis can be transformed by Y. lipolytica into fatty acids suitable for use in industry or other diverse applications. The yield of FAs produced by Y. lipolytica during growth in OP4 medium was comparable to related bioconversion processes. Growth of Y. lipolytica 78-003 in OP4 medium yielded 2.34 g L⁻¹ CDW, a biomass to substrate yield of 0.13 g gC⁻¹, and a FA to substrate yield of 0.03 g gC⁻¹ (0.54 g L⁻¹ FAs). Similarly, when Y. lipolytica was grown on 5 g L⁻¹ food oil waste, a FA-rich feedstock similar in hydrophobicity and carbon content to OP4 medium, the yield was 3 g L⁻¹ CDW and 0.75 g L⁻¹ FAs after 6 days. In general, lower FA accumulation is observed during growth of oleaginous yeast on hydrophobic substrates and additional measures must be taken to increase the yield of FAs.

Did cultivating Y. lipolytica on a PP-derived growth substrate impact FA production? By comparing FA production in OP4 medium versus a ‘surfactant control’, a few differences in the FA profile were evident, notably an increase the palmitoleic acid fraction, the presence of C 20 compounds and a larger product yield. On the other hand, a comparison of the C 16 and C 18 FA profile measured in this example during growth in OP4 medium with FA profiles reported by others revealed a similarities (Table 3). These data suggest that the Y. lipolytica FA profile is influenced by cellular metabolism rather than substrate characteristics. Additionally, by comparing FA profiles for cells grown on hydrophobic substrates (OP4 medium, hexadecane) and cells grown on hydrophilic substrates (glucose, starch), some differences were evident, notably the greater diversity of FAs produced during growth on the carbohydrate media. In general, the observed FA profiles were consistent with de novo lipid synthesis during growth on glucose and starch, where FAs are formed as secondary metabolites after nitrogen depletion warrants carbon storage and ex novo lipid synthesis during growth on OP4 medium and hexadecane, where FA synthesis is a growth-coupled process that assimilates hydrophobic substrates into lipids while simultaneously utilizing them for growth and maintenance. Overall, the data support the view that FA production by Y. lipolytica in a PP-derived medium is similar to FA production during growth on naturally-occurring substrates.

Two additional points regarding the presented data warrant further comment. First, Y. lipolytica did not grow as extensively in OP4 medium as it did in the ‘surfactant control’. The most likely explanation is that there were growth-inhibitory compounds associated with PP that were not present in the control, mainly cyclic alkanes. Cyclic alkanes are not an adequate growth substrate for Y. lipolytica, as the P450 monooxygenases mainly responsible for hydrophobic substrate oxidation during assimilation are not able to oxidize cyclic alkanes. This example shows that concentrations of cyclic alkanes as minimal as 0.23% w/v impeded growth. Notably, in spite of the lower biomass yield during growth on OP4 medium, the FA yield was significantly higher. Cellular stress, including nutrient limitations (Aggelis 2002; Andre et al. 2009; Beopoulos et al. 2008; Kitcha and Cheirsilp 2011; Klug and Daum 2014; Kuttiraja et al. 2016) increases FA storage by Y. lipolytica; chemical toxicity may have caused a similar stress response. Second, the PP component of OP4 medium contributed to Y. lipolytica growth and FA production. This result was evident in three ways. 1) gravimetric analysis of changes in the growth medium mass during experiments determined that 81% of the medium was taken up by Y. lipolytica. Even if all the non-PP components of OP4 medium were consumed first, these were less than half of the medium, meaning that at least 30% of the substrate taken up by Y. lipolytica was PP-derived. 2) The concentration of branched fatty alcohols in OP4 medium declined by 86% over the course of experiments. These compounds were the most abundant constituent of PP oil and were not part of the biodegradable surfactant in OP4 medium; the reduction in concentration indicates that Y. lipolytica assimilated at a minimum one major component of PP oil. 3) Y. lipolytica produced considerably more FAs when grown on OP4 medium than when grown on the ‘surfactant control’, indicating that PP-derived compounds contributed to FA production.

The production of FAs by Y. lipolytica can be optimized by altering fermentation conditions and by metabolic engineering. For example, supplementing a food oil waste-derived growth medium with 10 g L⁻¹ glucose increased the biomass yield from 3 g L⁻¹ to 13 g L⁻¹ with a concomitant increase in the FA yield from 0.75 g L⁻¹ to 7.3 g L⁻¹. Additionally, the bioavailability of the growth substrate can be increased; for example, bioconversion of waste cooking oil was enhanced by ultrasonication of the growth medium, leading to an increase in FA production. When the FA degradation and remobilization genes, Poxl-6 and TGL4, were inhibited, Y. lipolytica grown on 250 g L⁻¹ glycerol was able to obtain a lipid yield of 15.5 g L⁻¹, with lipid content constituting 31% CDW. Qiao (2015) determined that simultaneous overexpression of Y. lipolytica stearyl coA desaturase, acetyl-CoA carboxylase, and diacylglyceride acyl-transferase genes yielded a strain with fast cell growth and a high lipid titer (55 g L⁻¹). It is believed that adding carbon sources such as glucose or glycerol will favor biomass accumulation during the growth of the inoculum, and the larger microbial population should lead to quicker uptake of PP-derived compounds and greater FA accumulation. Alternatively, it is believed that overexpressing enzymes responsible for ex novo FA biosynthesis including fatty alcohol dehydrogenase, fatty alcohol oxidase, and fatty aldehyde dehydrogenase will favor FA accumulation over catabolism by peripheral pathways, leading to increased yields. Overall, bioconversion can be part of a terminal recycling solution for plastic waste.

TABLE 3
C 16 and C 18 FA profiles of Y. lipolytica growing on various
media in this and other work. Values are reported as percentages.

| | C 16:0 | C 16:1 | C 18:0 | C 18:1 | C 18:2 | Source |
|---|---|---|---|---|---|---|
| OP4 medium | 19 | 16 | 11 | 54 | n.d. | this work |
| Starch | 29 | 15 | 12 | 38 | 7 | this work |
| Glucose | 16 | 21 | 7 | 56 | n.d.^{a} | this work |
| Hexadecane | 46 | 15 | 10 | 25 | 4 | this work |
| Glycerol | 15 | 2 | 11 | 47 | 21 | (Aggelis |
| | | | | | | 2002) |
| Glycerol | 12 | 11 | 9 | 57 | 11 | (André et |
| | | | | | | al. 2009) |
| Glycerol | 13 | 17 | 6 | 55 | 7 | (Makri et |
| | | | | | | al. 2010) |

^{a}n.d.; not detected.

### Example: Bioconversion of Polyesters and Polyurethane

A process for bioconversion of polyesters (PET and PTT) and polyurethane (PU) have been developed. The process involves a depolymerization process based on alkaline hydrolysis, an emulsifying agent and a microorganism that is tolerant of alkaline pH. The polyester-derived growth medium is referred to as PTT1 medium herein.

Method: One g of PTT fiber is added to 4 ml of industrial grade ethanol (100 percent ethanol), 1 ml DMSO+0.41 g NaOH (18 percent w/v). The mixture is refluxed with heating 300-350° C. for 45 −60 min; the reflux allows for heating of the mixture without the ethanol evaporating. The heating process to depolymerize the fibers is as follows: in the first 5 min, no stirring, then stir for 10 min while the fibers crystallize into a white substance. Continue the heating/reflux for the remainder of the prescribed time, then let the system cool. The product will be a bluish, slurry with white crystals; it may also contain residual carpet materials such as polypropylene, calcium carbonate and adhesive. The bluish liquid is the alcohol fraction, containing the alcohol soluble components derived from PTT (propanol, propanal). The white crystals are the TPA. The pH during reflux is 12 to 13 and the pH of slurry is 12-12.5. The slurry can be centrifuged to separate the alcohol and TPA fractions, or the slurry can be added to an aqueous solution adjusted to pH=11 or 12 using NaOH. This latter step is used to make PTT1 medium. In PTT1 medium, the contents as described are added to 1 liter of pH adjusted water, while mixing; the added compounds will not precipitate. The pH of the resulting solution is adjusted to 9.5, typically using HCl and NaOH. 300 mg/l yeast extract is added as a N source. The yeast extract can lower pH, so it should be adjusted upward again to 9.5 with NaOH. Note that the TPA will precipitate if the pH becomes too low, usually around 8.5. Once the pH is adjusted, the medium can be autoclaved at 15 PSI, 121° C. for 20 minutes, without the production of white precipitate.

In order to use the medium in a bioconversion process, a microorganism tolerant of alkaline pH must be used. Industrial yeast Candida famata was used. This strain has a pH tolerance level of 9.5-10.5 and is oleaginous.

Features: It has been shown that an aqueous solution containing materials that only remain soluble at alkaline pH is suitable for a bioconversion process if the biocatalyst (microorganism) is tolerant of the pH. Polyesters can be depolymerized using reagents besides alcohols (e.g. glycerin). However, these suspensions form a precipitate in aqueous solutions. It has also been shown that if polyester is depolymerized in alcohol, all of the resultant chemical components remain soluble, i.e. the ethanol acts as an emulsifier, and they can be mixed with water. Additionally, if the alcohol is ethanol, then it can be metabolized by the biocatalytic microorganisms along with the polyester; in other words, it is biodegradable. PET and PTT can be processed together into a growth medium. Candida famata will accumulate fatty acids during growth in PTT1 medium.

PUprocess: the process that is described here for making PET/PTT medium also works to make a growth medium that contains polyurethane (PU). Preliminary data indicate that fungi can grow using the PU-containing medium.

Polystyrene process: postconsumer PS can be used as a carbon source to cultivate microorganisms to produce value added chemicals in a bioconversion process. The PS will be chemically depolymerized and then solubilized using compounds that emulsify it. Subsequently the depolymerized PS will be added to water and trace nutrients will be added to make a growth medium. Since PS is an addition plastic and cannot be hydrolyzed. To overcome this obstacle, PS was dissolved in a mixture of styrene oxide (SO) and acetone. The mixture results in an aqueous suspension. SO acts as an emulsifier to dissolve PS: It is believed that each molecule of PS is surrounded by molecules of SO. The acetone then acts to solubilize the PS/SO micelles in water. Each of the molecules involved are biodegradable by some microorganisms.

Method: Add 700 ul of acetone to 300 uL SO in a beaker. Mix well for 20 min with a vortexer to prepare a viscous solution. To the viscous solution, add 700 mg of PS foam in 60 mg aliquots. After each aliquot is added to the solution, it must be vortexed thoroughly to dissolve. The mixture becomes more viscous as more PS is added, eventually becoming a clear, golden-colored gel. Additional acetone can be added to aid in dissolving the PS foam. Add the gel to water to make a suspension, the volume of water could be 100 ml to 1000 ml, depending on the desired final concentration. Add 0.3 g yeast extract per liter.

Results: Micelles are evident in the medium (400× magnification). When Candida famata was added to the medium, it was observed microscopically to at least tolerate the medium and not die. An enrichment culture inoculated with kombucha resulted in isolation of a yeast that grew in the medium. Note: it may be possible to solubilize PS in a modified way that uses less reagents. In the proposed approach, a strong oxidizer such as potassium permanganate could be used to oxidize PS into SO and SO-like molecules that could make a self-emulsifying mixture.

OP4 and OP5: This process is used to convert polypropylene to single cell oil (SCO) and value-added chemicals via thermal depolymerization and fermentation. In this disclosure the organism that was used for the fermentation process was Yarrowia lipolytica 78-003 (ATCC designation 46483).

Description of the Related Art: Current processes in use do not employ a two-tier process that couples thermal depolymerization of polypropylene with microbial bioconversion of depolymerized polypropylene. The process described herein has at least two purposes: (1) to use polypropylene as a feedstock for industrial yeast, and (2) to create value-added chemicals from the polypropylene feedstock.

Polypropylene thermal depolymerization: Using a 125 ml flat-bottomed boiling flask, a condenser, a 500 ml filtering flask, a hot plate with 540° C. capacity, and 3 g of polypropylene (PP). The 3 g of PP are added to the boiling flask and the boiling flask is thoroughly flu shed with nitrogen prior to connecting to the condenser in order to create an oxygen-free environment. The flushed boiling flask is connected to the condenser via tubing, and a sealed connection is produced. Holed stoppers are used to connect the tubing to both the condenser and the boiling flask, as well as the boiling flask to the filtering flask. The filtering flask has tubing attached to its side arm that is sealed with a stopper. The hot plate is heated to 540° C., and the PP in the boiling flask is allowed to rise to 500° C. The PP is allowed to reach 500° C., then the PP is heated for 180 more minutes. After about 80 minutes, the flask contains depolymerized PP, referred to as “PP oil”.

“OP5” PP medium protocol: The PP oil, once allowed to cool to approximately 60° C., is then mixed with 1 ml Tween 80, and the resulting PP oil-Tween 80 mixture is mixed with 150 ml water, and transferred to a 250 ml screw top Pyrex bottle, and then homogenized at high setting with a handheld homogenizer.

Concurrently, for each 150 ml batch of homogenized PP oil-Tween 80 mixture, 1 g of Yeast extract without amino acids, 500 mg yeast extract 250 mg Mg₂SO₄, and 500 mg KH₂PO₄ are added to a 100 ml screw top borosilicate glass bottle containing 50 ml deionized water, and the mixture is stirred until all nutrients are in solution. The homogenized mixture and the nutrients solution are then autoclaved at 120° C. for 20 minutes. Once autoclaved, the nutrients mixture is added to the homogenized PP and Tween 80 mixture in a sterile manner.

Features of OP4 and OP5 media: Both OP4 and OP5 media contain substantially more PP per liter than OPI, the original formulation. OP5 medium is an improvement on the OP4 protocol. OP5 medium eliminates the need for oleic acid as an emulsifier.

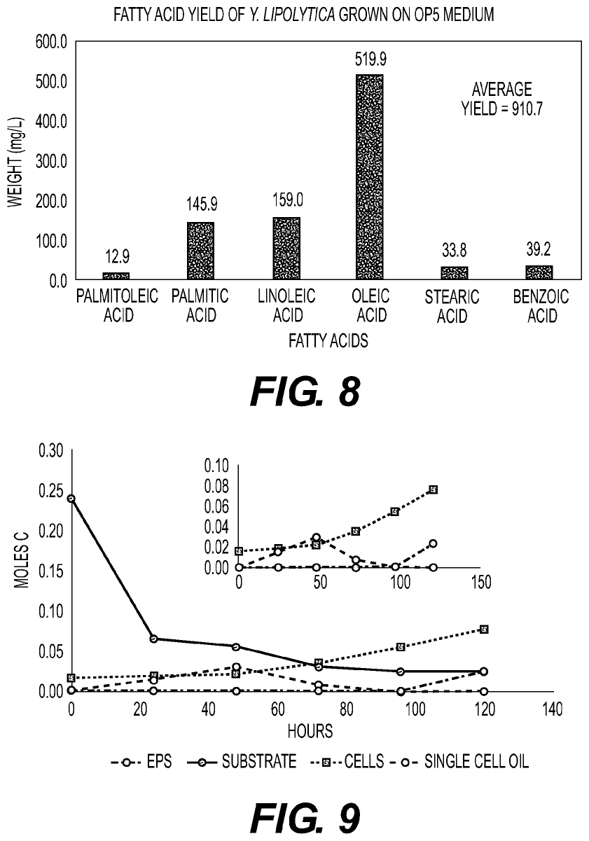

Results: After 120 hrs fermentation with Y. lipolytica (done in triplicate using 500 ml Erlenmeyer flasks with 50 ml OP5 medium in each) at an inoculation density of 0.60, Y. lipolytica produced an average lipid yield of 911 mg/L (FIG. 8). This yield was nearly twice the yield of fatty acids produced by Y. lipolytica during growth in OP4 medium at the same timepoint. The dominant fatty acid produced within that lipid yield was oleic acid, followed by linoleic, palmitic, benzoic, stearic, and palmitoleic acids (FIG. 8).

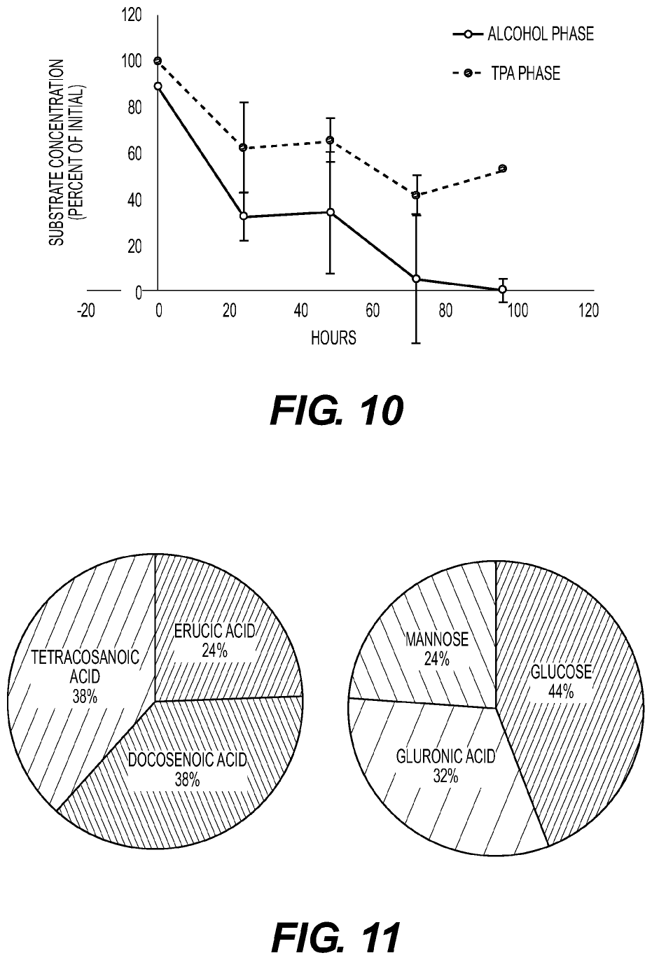

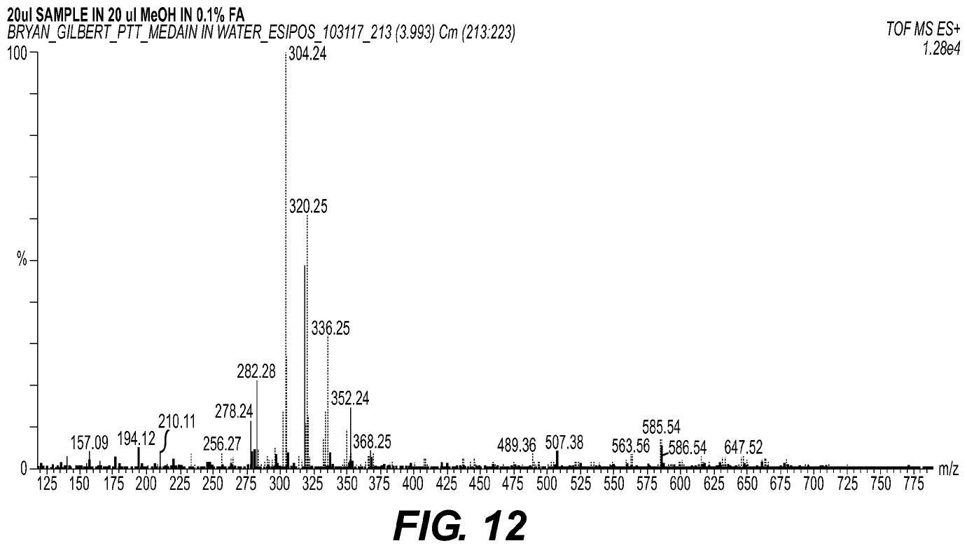

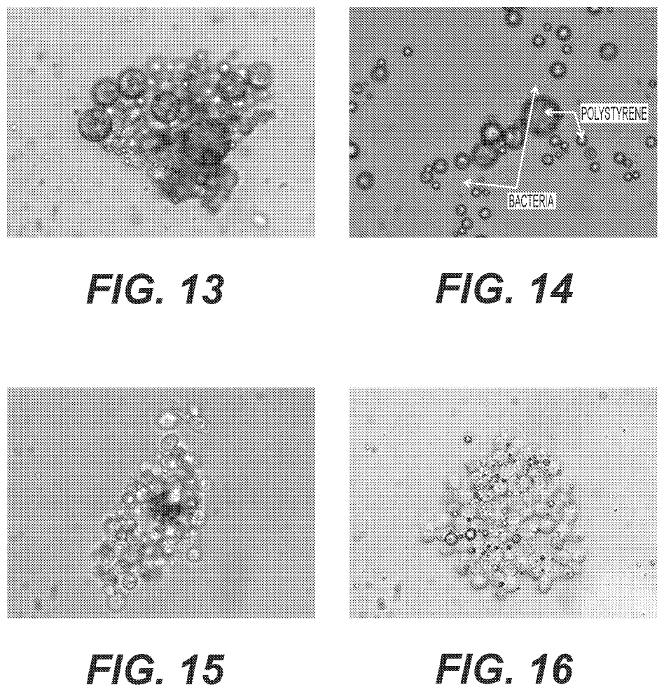

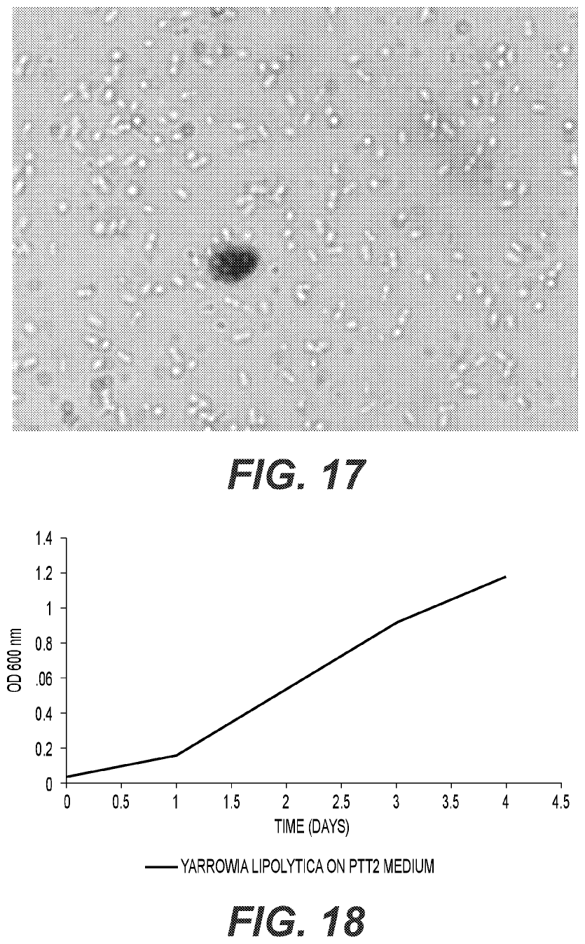

FIGS. 9-17 shows results from bioconversion of various depolymerized residue.

### Example: PTT/PET Medium Improvements: Neutral pH, Product Accumulation

Overview: This example describes an approach to making a polyester-derived growth medium for microorganisms requiring a neutral pH. In the previous example, a polyester-derived growth medium in which depolymerized PTT or PET remained in solution at alkaline pH was described. This medium was suitable for use in a bioconversion process by microorganisms that remained metabolically active at alkaline pH, but was not suitable for cultivating microorganisms adapted to grow at neutral pH. In the previous formulation, PTT1, it was observed that a precipitate derived from the depolymerized polyester compounds formed as the pH was lowered from alkaline to neutral. In contrast, in the instant exemplary formulation, the polyester-derived molecules remain in suspension at neutral pH. The significance of this is that numerous industrially significant microorganisms used for bioconversion and other bioprocesses function best at neutral pH. The method described in this example results in a plastic-derived growth medium suitable for cultivating diverse microorganisms including the Gram-negative organism Escherichia coli, yeast including Yarrowia lipolytica, and Gram-positive bacteria such as Bacillus subtilis. The neutral-pH medium described in the present example is referred to as PTT2 to differentiate it from the alkaline medium, PTT1.

Additionally, it was observed that when Candida famata grew in a polyester derived medium, either PTT1 or PTT2, a significant quantity of a green product accumulated extracellularly. C. famata is known as an industrial source of biologically-synthesized riboflavin.

Method: The following protocol was used to depolymerize polyester. One (1) g of PTT fiber was added to 4 ml of industrial grade ethanol (100 percent ethanol), 1 ml DMSO and 0.41 g NaOH (18 percent w/v). The mixture was refluxed with heating between 300-350° C. for 45-60 min (reflux allows for heating of the mixture without the ethanol evaporating). The heating process to depolymerize the fibers was as follows: in the first 5 mins, no stirring, then stir for 10 min while the fibers crystallize into a white substance. Heating/refluxing was continued for the remainder of the prescribed time, then the system allowed to cool. The product was a bluish slurry with white crystals. Some residual carpet materials such as polypropylene, calcium carbonate, and adhesive may be present in the mixture. The bluish liquid is the alcohol fraction, containing the alcohol-soluble components derived from PTT (propanol, propanal). The white crystals are the terephthalic acid (TPA). The pH during reflux was from 12-13 and the pH of the slurry was from 12-12.5.

The slurry was centrifuged to separate the alcohol and TPA fractions, or added to an aqueous solution with its pH adjusted to 11 or 12 using NaOH. In the PTT2 medium, the contents as described were added to 1 liter of pH adjusted water, while mixing (the added compounds did not precipitate). The pH of the resulting solution was adjusted to 9.5 (typically using HCl and NaOH) followed by bottling and autoclaving the solution for 30 min at 121° C., 15 psi. After autoclaving, the solution was allowed to cool. Subsequently, filter-sterilized yeast extract (300 mg/L) was added as a N source. The resulting pH was 6.7-6.8. In contrast to PTT1 medium, the PTT2 medium did not precipitate at the resulting neutral pH.

The approach described in this example for making a 1 g/L solution can be scaled up to 5 g/L by increasing the amounts of the required reagents proportionally; i.e. for a 5 g/L solution, add 20 mL 100% ethanol, 5 mL DMSO, 2.1 g NaOH.

Metabolite production: During growth of C. famata in PTT1 or PTT2, a whitish-green metabolite is detected provided that the inoculum density is a suitable concentration. The current data indicate that an inoculum density of 0.4 (600 nm) is too low, while an inoculum density of 16 (600 nm) is too high; however, at on OD 600 of 4.5, significant amounts of metabolite accumulate during growth. The metabolite is consistent with features of a tripeptide.

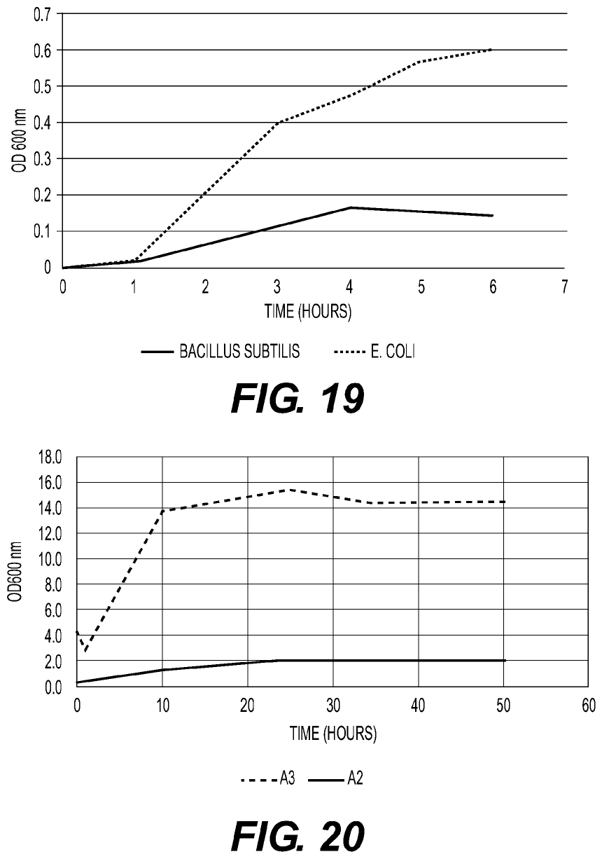

Growth of diverse microorganisms in PTT2 medium: PTT2 medium is derived from polyesters (PET and PET polymers). It is different than PTT1 medium because the plastic-derived compounds remain soluble in solution at neutral pH. In FIGS. 18 and 19, the medium is pH 8 and the concentration of polyester-derived materials is 5 g/L. FIG. 18 shows growth of Yarrowia lipolytica, an oleaginous yeast FIG. 19 shows growth of two kinds of bacteria, Escherichia coli (Gram −) and Bacillus subtilis (Gram+).

Accumulation of product from Candida famata during growth in PTT2 medium: Candida famata (CF) is an industrial yeast that was originally used to produce riboflavin. CF grows in PTT1 and PTT2 media and produces a colored compound that accumulates.

In FIG. 20, PTT media at a concentration of 1 g/L were inoculated using inoculum (OD600): A2-0.4 and A3-4.5. A green pigment was produced which was most visible in A3 treatment, only minimally visible in A2 treatment. This suggests that there are cofactors exchanged at higher cell density, leading to better growth with higher inoculum density. The green pigment production at 10 h may correspond to reduced iron concentration as a result of cell growth. Low iron may trigger riboflavin production.

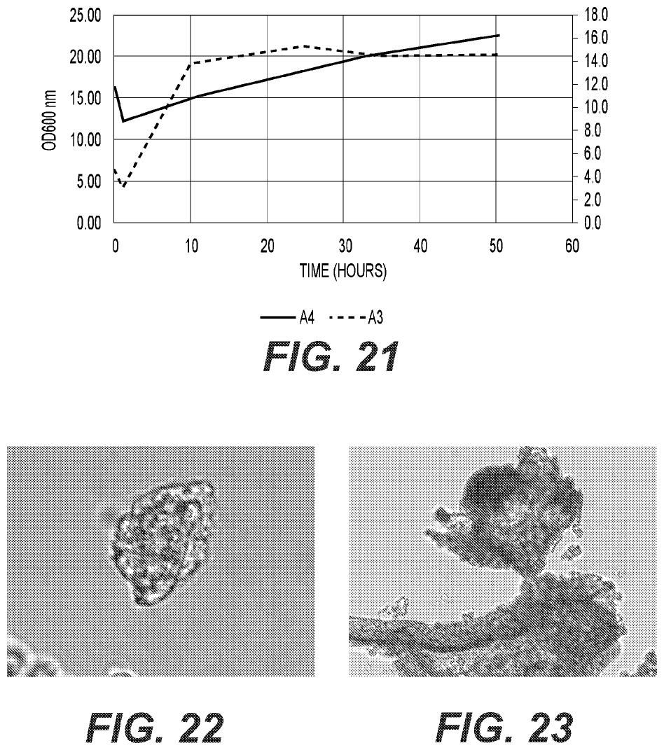

In FIG. 21, PTT media at concentrations of 1 g/L (A3 PTT) and 5 g/L (A4 PTT) were inoculated with inoculum (OD600): A4-16 and A3-4.5. By 6 h, the accumulated biomass of A3 was comparable to A4. No green pigment was detected at any timepoint in A4.

C. famata at 25 hours during growth in PTT1 forms a greenish-white product from culture supernatant that accumulated with the pellet during centrifugation.

C. famata at 35 hours during growth in PTT1 forms a greenish-white product accumulated as a precipitate on the surface-attached cells at the air-liquid interface.

FIG. 22 shows accumulating metabolite in PTT1 solution during growth of C. famata. The image is by brightfield microscopy, 1000× magnification after 25 h growth.

FIG. 23 shows crystal of metabolite accumulating in solution. Magnification 10×. Note small round green yeast cells. The crystal is hypothesized to result from secreted peptide which aggregates outside of the cell.

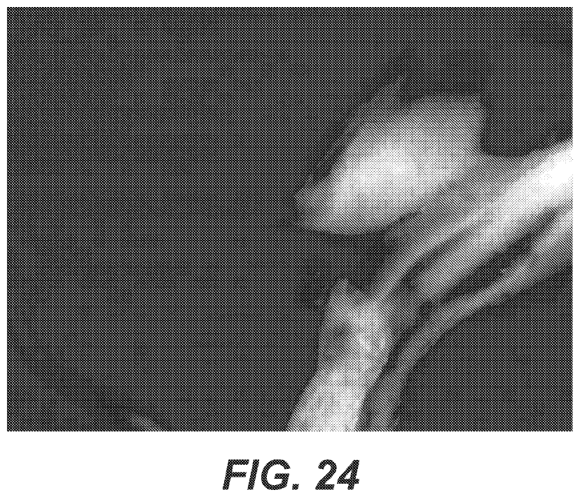

FIG. 24 shows the same crystal imaged with an epifluorescence microscope. Note the fluorescence using a rhodamine filter set. Magnification 10×. Fluorescence was also noted using the DAPI and FITC filter sets.

### Example: Enhancing Polypropylene Bioconversion and Lipogenesis by Yarrowia lipolytica by Optimizing Growth Medium and Fermentation Parameters

Plastic waste in the environment is a challenging problem that requires new approaches to solve. An improved polypropylene (PP) upcycling process that coupled pyrolysis with bioconversion by the oleaginous yeast Yarrowia lipolytica is described. Using virgin PP, pH, inoculum density, C/N ratio, and osmolarity were optimized which resulted in an increased fatty acid titer of nearly four-fold to 1.9 g L⁻¹, with 41% cellular fatty acid content, the highest content reported to date for plastic-to-lipid microbial bioconversion. The highest fatty acid titer was achieved with an inoculum density of 3 (OD 600 nm), pH=6.0 and C/N ratio of 80:1. Increasing the medium osmolarity by adding sodium chloride adversely affected cell growth and did not improve the fatty acid titer. The maximum fatty acid titer occurred under conditions that balanced cell growth versus lipogenesis. Using postconsumer PP, the fatty acid titer was significantly lower (0.13 g L⁻¹). Overall, the work demonstrates the potential and the challenges associated with microbial bioconversion of plastics.

Introduction: Plastic pollution in the environment is a challenging problem that requires innovative strategies to solve. Microbial bioconversion of plastics for producing value-added products is potentially part of the solution. In the example above, a process for microbial bioconversion of polypropylene (PP) that used the oleaginous yeast Yarrowia lipolytica to produce fatty acids was described. This process employed pyrolysis to depolymerize PP and create a hydrocarbon- and fatty alcohol-rich oil. The oil was mixed into a nutrient-supplemented aqueous solution using biodegradable surfactants including oleic acid, resulting in a PP-derived growth medium named OP4. Y. lipolytica was able to assimilate more than 80% of OP4, producing a titer of up to 440 mg L⁻¹ fatty acids, of which 51% was derived from PP. After demonstrating the potential for PP bioconversion using OP4 medium, a PP-derived growth medium that required less adjuvants and a process that could yield more product was developed. In this example, OP5 medium, a PP-derived growth medium that is free of oleic acid and derives 77 percent of its carbon from polypropylene is described. Several approaches to increase the product yield during the growth of Y. lipolytica in OP5 medium was tested and then examined the impact of using postconsumer PP waste in a bioconversion process.

The ability of Y. lipolytica to accumulate intracellular stores of lipids at high concentration has generated tremendous interest as a sustainable source of fatty acids, or “single cell oils”. The cellular lipid content of Y. lipolytica can account for 70 percent or more of the cell's biomass. Moreover, Y. lipolytica has been engineered for use as a microbial cell factory to produce a range of commercially significant biochemicals, including the platform chemical succinic acid. Importantly, Y. lipolytica has a broad substrate specificity, allowing it to use a wide range of chemical inputs, an essential characteristic for fermentation processes targeting postconsumer waste. Y. lipolytica uses lipid growth substrates via ex novo biosynthesis and can upcycle oily hydrophobic wastes including waste cooking oil and animal product wastes. The PP oil used to prepare OP5 medium is comprised of diverse hydrophobic compounds and is potentially a good substrate for bioconversion by Y. lipolytica. In this example, the inventors evaluated several growth conditions to increase the product titer during bioconversion of OP5 medium by Y. lipolytica and then examined the impact of using postconsumer PP waste on the bioconversion process.

Materials and Methods

Chemicals and Reagents: Virgin amorphous polypropylene pellets (Mw=14,000) were purchased from Sigma Aldrich (Millipore Sigma, USA). Tween 80@, chloroform, methanol, cyclohexane, and hexane and all culturing compounds were of research grade and purchased from Fisher Chemicals (Fisher Scientific, USA).

Polypropylene Growth Medium Preparation: OP5 medium is prepared as follows. 125-ml flat-bottomed borosilicate flasks were used to pyrolyze either virgin PP pellets or sheared postconsumer PP in 3 g batches at 540° C. for 195 minutes. The pyrolysis oil (at 15 g L⁻¹) was combined with: 5.4 g L⁻¹ Tween-80@, 5 g L⁻¹ yeast nitrogen base, 2.5 g L⁻¹ KH₂PO₄, 2.5 g L⁻¹ yeast extract, and 1.25 g L⁻¹ MgSO₄ 7H₂O. The mixture was emulsified with a hand-held food-grade homogenizer. To compensate for the lack of oleic acid as an emulsifier, the homogenization time of OP5 medium was increased from 90 seconds (mixing time for OP4 medium) to 3 minutes. The resulting homogenized medium was autoclaved for 30 min at 121° C. and 15 psi.

Cultures and Fermentation Conditions: Yarrowia lipolytica ATCC strain 46482 was the strain used in this work. Overnight cultures were prepared from 1 ml 60% glycerol stocks of Y. lipolytica stored at −80° C. For all experiments, frozen cells were thawed and used to inoculate 250 ml Erlenmeyer flasks containing 50 or 100 ml of Yeast-Extract-Peptone-Dextrose medium (10 g L⁻¹ yeast extract, 20 g L⁻¹ peptone, and 20 g L⁻¹ dextrose). Inoculated flasks were incubated overnight at 30° C. with shaking at 200 rpm overnight. 1 ml aliquots of overnight cultures were withdrawn and used to measure yeast growth via absorbance. All shake flask fermentations were conducted using 500 ml Erlenmeyer flasks containing 50 ml OP5 medium; triplicate flasks were inoculated with an overnight culture of 30 Y. lipolytica at varying inoculum densities (OD₆₀₀ ml-1) and incubated at 30° C. with shaking at 200 rpm.

Growth Measurements: Y. lipolytica growth measurements were taken spectrophotometrically and gravimetric measurements. Y. lipolytica culture aliquots of 1 ml were withdrawn, and growth was measured via optical density at 600 nm using an Eppendorf 6131 Biophotometer (Eppendorf, USA). For growth measurements using gravimetric methods, 50 ml volumes of culture were withdrawn after fermentation and centrifuged at 7,000 rpm. Supernatant was decanted and stored, and cell pellets were washed twice with 50 mM Phosphate Buffered Saline (PBS) solution. Cells were then flash frozen in liquid nitrogen and lyophilized overnight using a BT3.3 EL Lyophilizer Tabletop (SP Scientific, USA) and weighed.

Microscopy: Brightfield microscopy images were taken using a AmScope BL120c microscope (United Scope, USA) equipped with an AmScope MD35 camera attachment at 1000× magnification. Slides were prepared by aseptically pipetting 10 μl of OP5 medium containing Y. lipolytica after 120 h growth. No stains were used.

Fermentation Optimization: For fermentation optimization experiments, pH, inoculum density, osmolarity, or carbon-nitrogen ratio were altered. For pH experiments, OP5 medium pH was adjusted to 4.0, 5.0, or 6.0 using 2.0 M H₂SO₄ or 4.0 M NaOH. A Corning 320 pH meter (Corning, USA) was used to measure pH. For starting inoculum density experiments, OP5 medium was inoculated at an inoculum density of either 1.0, 3.0, or 6.0. Aliquots of 1 ml were retrieved from Y. lipolytica overnight culture and inoculum density was measured via absorbance at 600 nm. Based on absorbance readings, a volume of cells corresponding to the desired inoculum density was retrieved from the overnight culture and centrifuged at 4,000 rpm. Pelleted cells were washed twice with 50 mM PBS solution and used to inoculate OP5 medium. For osmolarity experiments, NaCl salt was used to alter the medium's osmolarity. NaCl was added to OP5 at concentrations of 0.75, 1.5 and 3 g L⁻¹ prior to autoclaving of the medium. For carbon-nitrogen ratio experiments, nitrogen content in OP5 medium was altered by modifying amount of yeast extract (contains 10% nitrogen w/v) and yeast nitrogen base (contains 15% nitrogen w/v) added to the OP5 medium prior to autoclaving, and a medium pH of 6.0 and inoculum density of 3.0 were used carbon-nitrogen ratios of 20, 40, 80, and 100 were tested. After the selected parameters were altered, shake flask fermentations were carried out for 120 hours, after which cells were processed and biomass and lipid product formation were analyzed as described below.

Substrate Assimilation Analysis: The uptake of growth substrate in OP5 medium was measured gravimetrically. 50 ml of either pre-fermentation or spent OP5 medium were added to 50 ml conical tubes and lyophilized. After all moisture was removed, the remaining mass of medium was weighed, and substrate uptake was determined as the different in the mass of medium solids before and after fermentation.

GC/MS analysis of OP5 medium components: The inventors quantified the consumption of organic constituents of OP5 medium during fermentation by GC/MS. Liquid-liquid extractions were used to collect the organic constituents before and after the growth of Y. lipolytica in OP5 medium. Fifty ml hexane was added to 50 ml pre-fermentation or spent OP5 media, and the mixture was transferred to 250 ml screw cap Nalgene tubes, sealed with Teflon tape, and shaken at 30° C. and 150 rpm for 24 hours. After incubation, samples were centrifuged at 5000 rpm for 10 minutes, and 1.5 ml of the hexane (top) layer was withdrawn and used for GC/MS analysis. The GC method of Guzik (2014) was used to characterize and quantify the constituents of the hexane layer (Guzik et al., 2014). Details about the GC/MS instrumentation and protocol are described below. One μl was injected via automatic liquid sampler at an inlet temperature of 275° C. The oven method was: 30° C. for 1 min, then ramping to 100° C. (rate: 7.5° C. min⁻¹), then ramping to 300° C. (rate 10° C. min⁻¹, hold 2 min). Separated peaks were quantified using MassHunter® Qualitative Analysis software (Agilent, USA).

OP5 medium components: impact on product titer: Media were made using the various components of OP5 medium. Each component medium was made using deionized water and buffered to a pH of 6.0 using 0.1 M HCL or 0.1 M NaOH. Tween® 80 only medium contained 5.4 g L⁻¹ Tween® 80 surfactant only. PP-only medium was composed solely of 15 g L⁻¹ PP oil. Tween® 80+ nutrients medium was composed of 5.4 g L⁻¹ Tween® 80 surfactant, 5 g L⁻¹ yeast nitrogen base, 2.5 g L⁻¹ KH₂PO₄, 2.5 g L⁻¹ yeast extract and 1.25 g L⁻¹ MgSO₄·7H₂O.

Component media experiments were carried out in 500 ml Erlenmeyer flasks containing 50 ml medium, and Y. lipolytica was inoculated at an inoculum density of 1.0. Samples were placed in a shaking incubator for 120 h at 30° C. After fermentation, samples were transferred to 50 ml conical tubes, and centrifuged at 4,000 rpm for 10 minutes. The supernatant was decanted and cells washed twice with 50 mM PBS before being lyophilized, weighed as described above, and lipids extracted and quantified as described in the following section.

Intracellular Lipid Quantification: A previously used modified Bligh and Dyer extraction was used to extract lipids from yeast samples. Post-fermentation OP5 culture was withdrawn and dispensed into pre-weighed 50 ml conical tubes prior to centrifugation at 4,000 rpm, and pellets were washed twice with 50 mM PBS solution. Pellets were lyophilized, weighed, suspended in a 2:1 v/v chloroform: methanol mixture (5 ml per 50 mg cell dry weight) and sonicated using a Sonic Dismembrator (Fisher Scientific, USA) at 20 kHz and 20% amplitude with pulsing (40 s on, 20 s off for a total working time of 20 min). The chloroform layer was withdrawn and aliquoted into pre-weighed conical tubes, then dried under a nitrogen stream. Dried lipids were weighed to determined lipid yield.

Dried lipids were weighed and methylated for GC/MS analysis via base-catalyzed esterification with 2.5 ml sodium methoxide (0.1 M). The reaction was quenched using 200 μl sulfuric acid (>95%), and 2.5 ml hexane was added to each sample, which was then vortexed and centrifuged for 10 min at 10,000 rpm. 1.5 ml from the top hexane layer was withdrawn for GC/MS analysis.

GC/MS Analysis of Lipid Profile: Fatty acid profiles were characterized with an Agilent 7890A gas chromatograph attached to a 5977A mass spectrometer detector and equipped with an Agilent J&W HP-5 ms UI capillary column (30 mm×0.25 mm×0.25 μm). 1 μl samples were injected via an Agilent 7693 Automatic Liquid Sampler in splitless mode with an inlet temperature of 275° C., using helium as the carrier gas at a flow rate of 1 ml min⁻¹. GC oven temperature was held at 60° C. for 1 min, and ramped to 100° C. (rate: 25° C. min⁻¹; hold 1 min). The oven temperature was then increased to 200° C. (rate: 25° C. min-1; hold 1 min). The oven temperature is then increased to 220° C. (rate: 5° C. min⁻¹; hold 7 min) and then increased to an ending temperature of 300° C. (rate: 25° C. min⁻¹; hold 2 min). A C8-C24 FAME analytical standard was used during sample analyses as an external standard (Sigma Aldrich, USA).

Postconsumer PP oil characterization via GC/MS: 3 g postconsumer PP oil was dissolved in 250 ml chloroform (Sigma Aldrich, USA) and 1.5 μl aliquots were analyzed via GC/MS. A GC method was used to characterize the polypropylene pyrolysis oil. 1 μl of the diluted pyrolysis oil was injected via automatic liquid sampler at an inlet temperature of 275° C. The oven method was 30° C. for 1 min, then ramping to 100° C. (rate: 7.5° C. min⁻¹), then ramping to 300° C. (rate 10° C. min⁻¹, hold 2 min).

Statistical analysis: Significance was analyzed using either one-way or two-way ANOVA or Student's t-test assuming unequal variance with the data analysis package included with Microsoft Excel. Experiments were carried out at minimum in triplicate.

Results

OP5 medium composition: Microbial bioconversion has potential for upcycling plastic waste into value-added biochemicals. In previous work, we demonstrated that thermal depolymerization of PP could be used to make a microbial growth medium suitable for Y. lipolytica to grow and produce fatty acids. In this example, the inventors report an improved PP-derived medium that did not require oleic acid as an emulsifier. By removing oleic acid, the amount of carbon derived from PP increased from 51 percent in OP4 medium to 77 percent in OP5 medium.

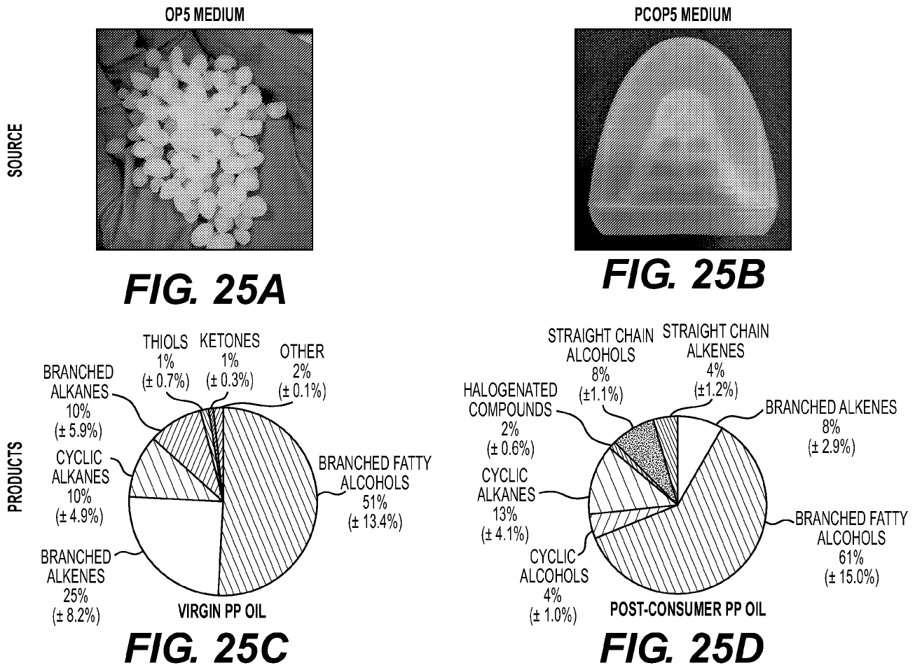

The PP oil in OP5 medium was comprised primarily of branched fatty alcohols including 2-hexyl-1-decanol and 2-methyl-1-decanol (59%) and the branched alkenes 2,4 dimethyl-heptene and 2,6 dimethyl-octene (16%) (FIG. 25C). This was similar to the PP oil used in OP4 medium which contained 51% branched fatty alcohols and 25% branched alkenes. After homogenization, the medium had a milky appearance and remained homogeneously mixed during the fermentation process by shaking on a rotary shaker. In the absence of mixing, the hydrophobic components in the medium aggregated into small droplets over a period of 24-48 h. Unlike OP4 medium, which contained oleic acid as an added emulsifier and remained homogenized at room temperature for a period of up to 3 days, OP5 medium separated within 2 hours without constant mixing. To compensate for this, the medium was used within an hour of homogenization and sterilization to prevent separation prior to fermentation.

Over the course of experiments, OP5 formed a colloidal suspension where depolymerized PP aggregated into small droplets (<50 μm diameter) dispersed throughout the medium. By microscope, these droplets were shown to associate with Y. lipolytica, which formed cell aggregates around the droplets.

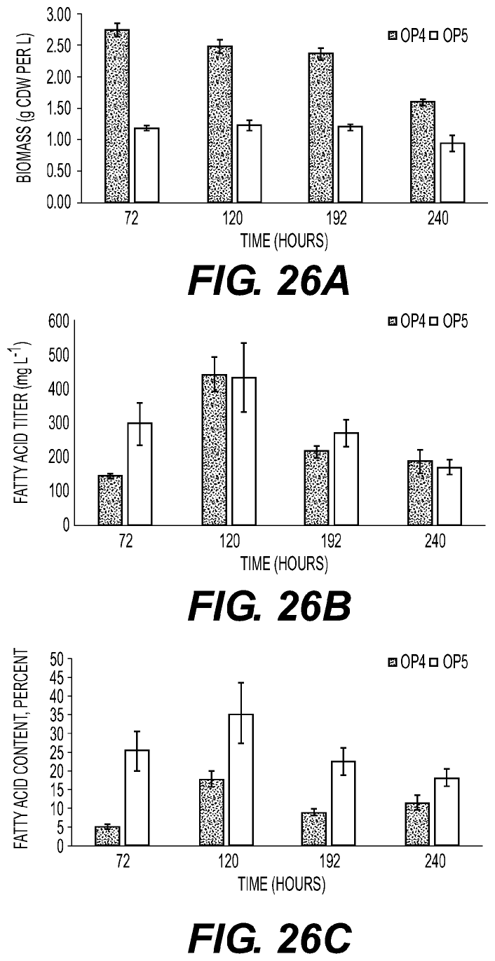

Growth and lipogenesis on OP5 medium versus OP4 medium: The growth of Y. lipolytica in OP5 medium versus OP4 medium over a 10-day period were compared to determine if the medium composition would affect cell yield, fatty acid titer or intracellular fatty acid content (FIG. 26). Cells grown on OP5 medium had fatty acid yields comparable to that of cells grown on OP4 medium. Cells grown on OP5 reached intracellular fatty acid yields of 0.43 g L⁻¹, similar to the maximum lipid yields of cells grown on OP4. Biomass yields were lower (p<0.05) when cells grew in OP5 medium, as the maximum biomass generated on was 1.1 g L⁻¹, less than half that of Y. lipolytica grown on OP4 medium. While cell biomass was low, cell lipid content had markedly increased, as OP5 grown cells had a higher lipid content than their OP4 counterparts at each timepoint measured. Cells grown on OP5 were able to achieve a maximum mean cell fatty acid content of 35 percent, compared to only 18 percent for cells grown on OP4. These findings suggested that the oleic acid in OP4 medium benefitted biomass formation by Y. lipolytica; in contrast, the high percentage of branched compounds in OP5 medium may have slowed Y. lipolytica growth. The absence of preferred growth substrates in OP5 medium may have increased cellular stress, signaling Y. lipolytica to synthesize storage lipids.

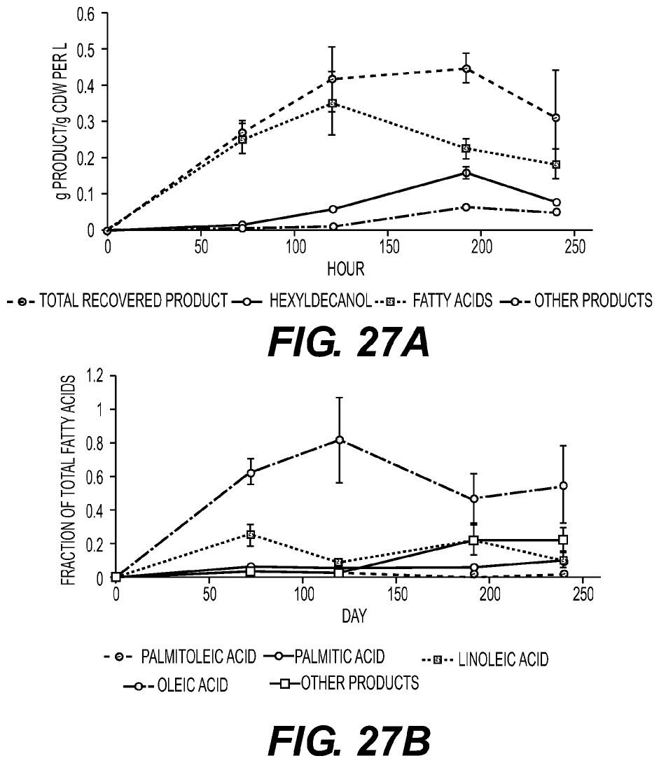

Dynamics of OP5 medium metabolism: Two distinct phases of physiological activity were evident over the 10-day experiment described above (FIG. 27A). During the first five days, Y. lipolytica was in the oleaginous phase, as seen by the positive rate of fatty acid accumulation. Fatty acid storage occurred most rapidly in the first 3 days. After day 5, the intracellular fatty acid content decreased, indicating a transition to the reserve lipid turnover phase. Coinciding with a decreased rate of fatty acid storage beginning at day 3, an increase in 2-hexyl-1-decanol (HD) was measured in the recovered product. HD is the major constituent of OP5 medium (FIG. 25). The pattern of HD accumulation over time was consistent with HD metabolism during the oleaginous phase followed by accumulation once storage lipid production began to slow starting on day 3. On the other hand, the pattern of HD accumulation over time was not consistent with HD entering the recovered product as a contaminant sorbed to the cell membrane. If this were so, the HD concentration would correlate with biomass, which followed a different pattern of change over the course of the experiment (FIG. 26B).

The composition of the recovered fatty acids was mostly consistent over the course of the 10-day experiment (FIG. 27B). Oleic acid was the major product and was at least 60 percent of the accumulated fatty acids after day 3. Linoleic acid was the next most abundant compound in the recovered product until day 5, when other mostly unidentifiable products began to accumulate. The other products included 2,4-di-tert-butylphenol (2,4-DTPB), a naturally occurring bioactive compound with antimicrobial activity, at concentrations reaching 3 percent of the total recovered product. The presence of 2,4-DTPB suggested that the accumulation of other products may be part of a competitive response as Y. lipolytica adapts to depleted nutrient concentrations in its environment. In general, the profile of the recovered fatty acids differed from the composition of PP oil found in OP5 medium. Oleaginous yeasts are noted for their ability to modify hydrophobic substrates during ex novo biosynthesis, resulting in an altered profile in the accumulated lipids relative to the growth substrate.

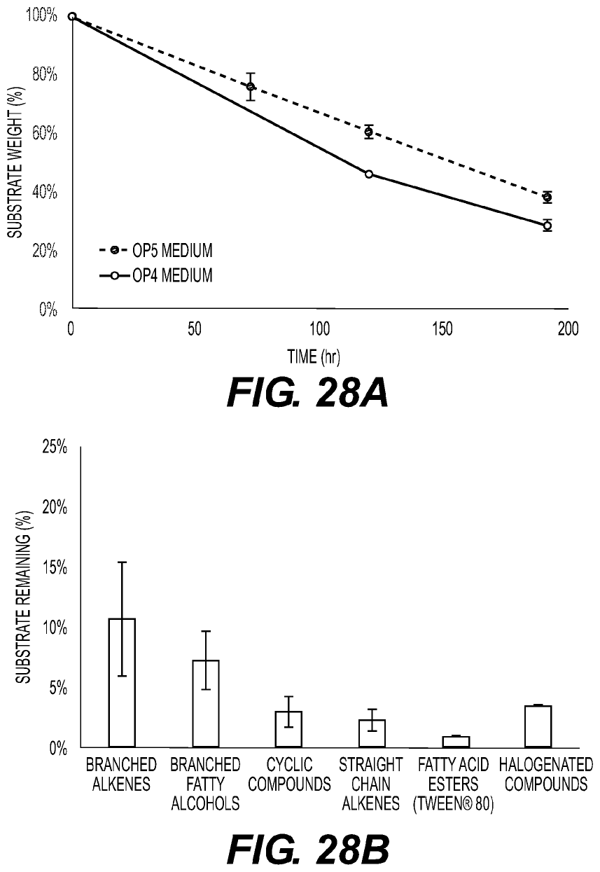

OP5 medium substrate uptake and PP utilization during fermentation: Experiments were conducted to determine the rate of OP5 medium uptake by Y. lipolytica and to profile the constituents that were assimilated. Bulk substrate assimilation was measured gravimetrically over a 192 h period. Y. lipolytica took up 39 percent of the bulk OP5 substrate by 120 hours, a lower amount than when grown on OP4 medium, when 53 percent was assimilated by the same timepoint (FIG. 28A). By 192 hours, Y. lipolytica assimilated 62 percent of the bulk OP5 substrate, compared to 71 percent when grown on OP4 medium. The overall trend of substrate assimilation for the two media was similar. Vasiliadou (2018) reported concentration-dependent uptake by Y. lipolytica for unsaturated fatty acids, with greater lipogenesis at concentrations of 25-35 g L⁻¹. In this example, the working concentration of OP5 medium was 15 g L⁻¹; it is possible that a higher concentration could promote more extensive lipid storage. Additionally, a low rate of substrate uptake can result in storage lipid degradation, a process that can potentially be delayed by adding a second substrate to the growth medium.

An analysis of the composition of pre-fermentation OP5 medium in comparison to spent OP5 medium was carried out to determine which PP oil constituents were taken up by Y. lipolytica during the fermentation process (FIG. 28B). OP5 medium was extracted into hexane at t=0 h and t=120 h, and the recovered analytes were quantified by GC/MS. The analysis showed 89-99 percent reduction in the peak area of all detected PP oil constituents.

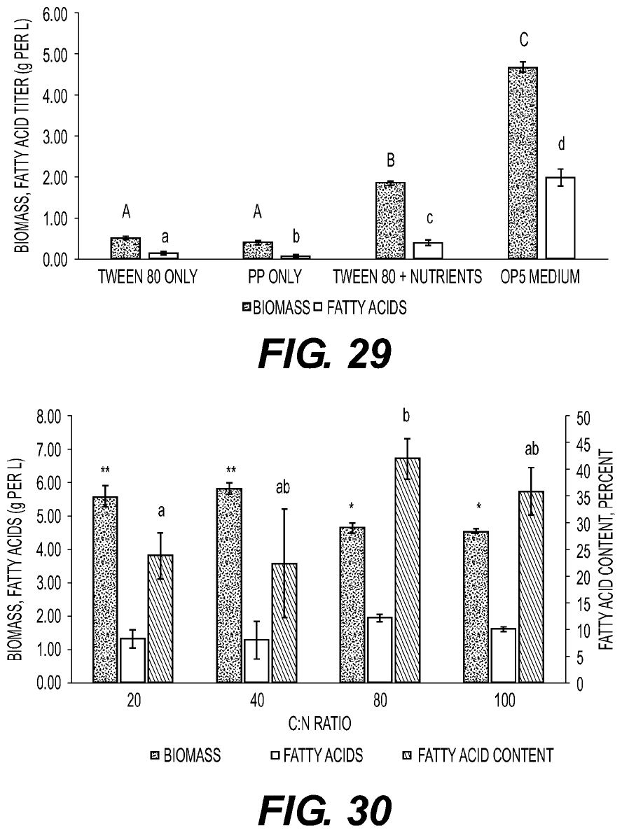

OP5 medium components, including the surfactant Tween® 80, can potentially affect Y. lipolytica growth and lipogenesis. To determine the contribution of individual medium components to Y. lipolytica lipogenesis during growth in OP5 medium, cells were grown on media composed strictly of PP (“PP only”), Tween® 80 (“Tween® 80 only”), or OP5 medium minus PP oil (“Tween® 80+ nutrients”) (FIG. 29). Biomass and fatty acid titers were compared with those from growth in OP5 medium. Cells grown on OP5 medium had 2.6 times higher biomass titer and 5.0 times the fatty acid titer when compared to cells grown on the “Tween® 80+ nutrients”. By comparing the fatty acid titer from OP5 medium with that of “Tween 80+ nutrients”, it was determined that 80 percent (1.6 g L⁻¹) of the fatty acids produced were attributable to carbon derived from PP, with the remainder (0.4 g L⁻¹) was attributable to carbon from Tween® 80. This analysis excluded the possibility that the majority of fatty acids measured in the product were derived from Tween® 80 rather than from the bioconversion of PP. The fatty acid yield (gram fatty acids produced per gram PP consumed) was 19 percent.

Starting medium pH and inoculum density significantly effect growth and lipogenesis: Lipid storage by oleaginous yeast is a physiological adaptation to stress. This creates a challenge for maximizing the lipid titer because the per-cell lipid production is greatest when conditions for cell growth are poor, resulting in low biomass. Conversely, when conditions for cell growth are permissive, lipid storage is low. These behaviors were evident in the presented data in two places. First, a comparison between Y. lipolytica growth in OP4 medium versus OP5 medium demonstrated higher biomass accumulation during growth in OP4 medium but significantly greater cellular fatty acid content during growth in OP5 medium (FIG. 26). These results correlate with the presence of easily assimilated oleic acid in OP4 medium, which was absent in OP5 medium.

Several different parameters that have been reported to affect Y. lipolytica metabolite production by others were examined, including pH, inoculum density, C:N ratio and osmolarity. First investigated was the impact of pH and inoculum density on growth, product yield and cell lipid content (Table 4). This was done by inoculating OP5 medium at varying initial pH (4.0, 5.0, and 6.0) at various inoculum densities (1, 3 and 6). At pH=4.0 and low inoculum density, a more stressful condition, growth was the least and fatty acid content per cell was the greatest; conversely at pH=6.0 and high inoculum density, a more permissive condition, growth was the greatest but fatty acid content per cell was the lowest. The highest overall fatty acid titer occurred at pH=6.0 and inoculum density of 3.0, a set of conditions which were intermediate relative to the others; it is notable that under these conditions, neither the growth nor the per-cell fatty acid content was the highest. These findings were comparable to previous studies, which showed that Y. lipolytica inoculum size affected both growth and product formation during fermentation, with lower inoculum density favoring higher cellular lipid content and higher inoculum density favoring biomass. Hereafter, an inoculum density of 3.0 and pH=6.0 was used for all further experiments. It was found that growth was the lowest at an inoculum density of 1 and pH=4 (1.3 g L⁻¹) and highest at an inoculum density of 6 and pH=5 (11.9 g L⁻¹) (Table 4). Conversely, the lipid content per cell was highest at an inoculum density of 1 and pH=4 (1.4 g L⁻¹) and lowest at an inoculum density of 1, pH=5 (0.5 g L⁻¹) (Table 4). The highest overall lipid yield was with at an inoculum density of 3, pH=6. Hereafter, an inoculum density of 3 and pH=6 was used for all further experiments.

TABLE 4
Effect of pH and inoculum density (ID) on Y. lipolytica
growth and lipid production in OP5 medium. ^{ab} Inoculum
density is presented as optical density of cells at
600 nm of cells in OP5 medium at t = 0.

| | | |
|---|---|---|
| ID^{b} = 1.0 | ID = 3.0 | ID = 6.0 |

Biomass^{a}

| | | | |
|---|---|---|---|
| pH 4.0 | 1.31 ± 0.08 | 2.84 ± 0.57 | 4.81 ± 0.08 |
| pH 5.0 | 1.38 ± 0.10 | 1.81 ± 0.09 | 11.89 ± 0.01 |
| pH 6.0 | 1.70 ± 0.05 | 5.83 ± 0.16 | 4.25 ± 0.11 |

Fatty Acid Titer^{a}

| | | | |
|---|---|---|---|
| pH 4.0 | 0.72 ± 0.09 | 0.63 ± 0.07 | 0.60 ± 0.02 |
| pH 5.0 | 0.39 ± 0.14 | 0.64 ± 0.15 | 0.93 ± 0.09 |
| pH 6.0 | 0.78 ± 0.09 | 1.31 ± 0.57 | 1.09 ± 0.18 |

Fatty Acid Content^{c}

| | | | |
|---|---|---|---|
| pH 4.0 | 0.51 ± 0.03 | 0.20 ± 0.03 | 0.11 ± 0.01 |
| pH 5.0 | 0.26 ± 0.09 | 0.33 ± 0.08 | 0.07 ± 0.01 |
| pH 6.0 | 0.42 ± 0.10 | 0.21 ± 0.09 | 0.24 ± 0.04 |

^{a}Biomass and lipid yield figures are presented as g L⁻¹.
^{b}ID, inoculum density (optical density, 600 nm). See Methods for details.
^{c}Fatty acid content is the ratio of fatty acid mass to biomass.

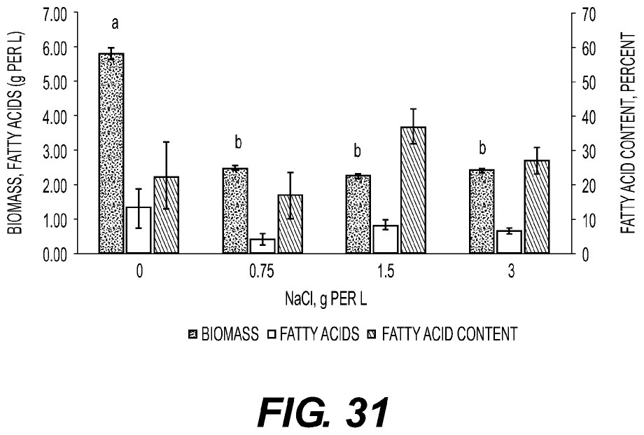

Carbon-to-Nitrogen ratio optimization improves lipid yield: Several environmental factors have been demonstrated to affect product formation in Y. lipolytica, including the C/N ratio and the osmolarity of the medium. A C/N ratio greater or equal to 80 resulted in an increase in fatty acid titer (FIG. 30). An increasing C/N ratio signals nitrogen scarcity and can trigger lipid storage when Y. lipolytica metabolizes a hydrophilic substrate by de novo biosynthesis. In contrast, ex novo biosynthesis of hydrophobic substrates is nitrogen-independent. The presence of fatty acids will frequently repress de novo biosynthesis but it has been recognized that both processes can occur simultaneously. After optimizing starting inoculum density and medium pH, C/N ratio was studied to select for the best ratio for optimal lipogenesis. OP5 shake flask fermentations at an inoculum density of 3 and a medium pH of 6 were performed for 120 hours, and C/N ratios of 20, 40, 80, and 100 were analyzed. The response to the increasing C/N ratio seen in FIG. 30 indicated that, in addition to ex novo biosynthesis of PP-derived hydrophobic compounds, de novo biosynthesis took place when Y. lipolytica grew in OP5 medium. This result suggests that at least one non-hydrophobic substrate was present in the growth medium in addition to PP oil. A potential hydrophilic compound in OP5 medium that could support de novo biosynthesis is the polysorbitan moiety from Tween 80. Increasing osmolarity, which significantly influences erythritol formation in Y. lipolytica, did not have a positive effect on fatty acid formation (FIG. 31). Overall, parameter optimization resulted in a fatty acid titer of 1.6 g L⁻¹, a nearly 4-fold increase in fatty acid titer compared to the original cultivation conditions. This is the highest reported product titer to date from a plastic bioconversion process, eclipsing previous fatty acid and polyhydoxyalkanoate (PHA) titers from PP (0.44 g L⁻¹) or PE (0.5 g L⁻¹), respectively.

Postconsumer polypropylene impacts Y. lipolytica lipogenesis: To simulate the real-world applicability of the exemplified process, the inventors compared lipogenesis by Y. lipolytica during growth in OP5 medium (derived from virgin PP pellets) and PCOP5 medium (derived from postconsumer PP packaging) (FIG. 25). The carbon profiles of virgin and postconsumer PP pyrolysis oils were similar in that both PP oil sources had majority branched fatty alcohols. Virgin PP oil contained 20 different compounds, with most of the carbon compounds (51%) being branched fatty alcohols, followed by branched alkenes (16%), cyclic compounds (12%), and straight chain alkenes (6%). In comparison, 25 different carbon compounds were found in postconsumer PP oil, with 61 percent of those being branched fatty alcohols, followed by cyclical compounds (15%), branched alkenes (8%) and straight chain alcohols (8%).

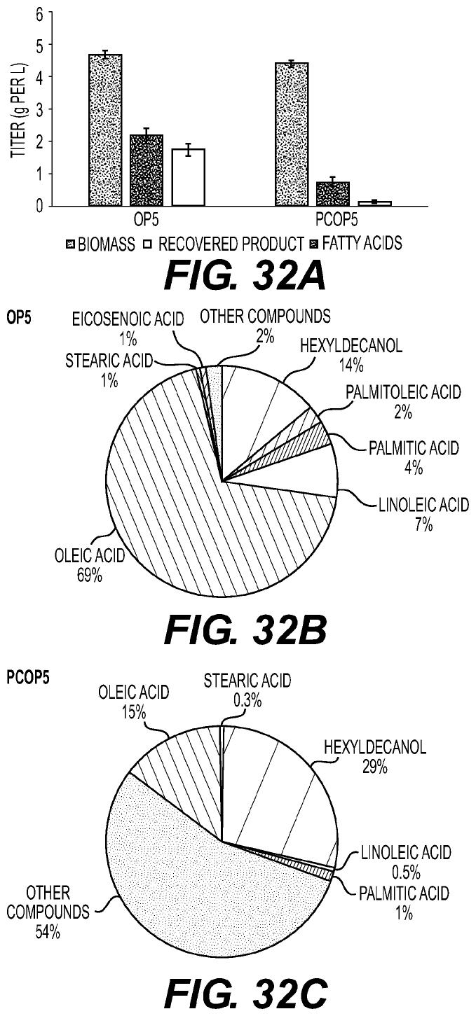

Biomass titers during Y. lipolytica growth in PCOP5 medium were comparable to those measured during growth in OP5 medium (FIG. 32). In contrast, the total recovered product from PCOP5-grown cells was approximately one third of the amount recovered from OP5-grown cells and the cell fatty acid content was markedly lower from cells grown in PCOP5 medium: just 6% of the amount produced by OP5-grown cells. Overall, the total recovered product from Y. lipolytica after growth in PCOP5 medium contained less than 20 percent fatty acids, with the remainder comprised of HD and other products.

Unlike virgin PP, postconsumer PP contains additives to promote stability and longevity. Some of the most common additives used in PP packaging include antioxidants, slip agents and heat stabilizers. The inventors hypothesized that heavy metal-based slip agents and organophosphate antioxidants, compounds used to delay oxidative stress caused by UV radiation, may be impeding lipogenesis in Y. lipolytica. It has been shown that antioxidants can impede lipogenesis in hepatocytes by preventing reactive oxygen species from inducing lipid accumulation. Heavy metals such as cadmium, tin, and lead have also been shown to increase ER stress and lipid peroxidation in eukaryotic cells, and might be negatively influencing Y. lipolytica lipogenesis. Overall, the composition of the recovered product after growth in PCOP5 medium indicated impaired bioconversion of HD to fatty acids, resulting in HD accumulation. Additionally, the high percentage of other compounds in the recovered product suggested that much of the carbon originating in PCOP5 was channeled into other metabolic pathways. In contrast, during growth in OP5 medium, other products did not begin to accumulate until after 5 days of growth (FIG. 27A). In sum, the growth medium derived from postconsumer PP has additional complexities associated with its metabolism compared to virgin PP.

Y. lipolytica has evolved to accumulate storage lipids when carbon is abundant and to use this reservoir for supporting metabolic activities when nutrients become scarce. Optimizing single cell oil production by Y. lipolytica requires maximizing lipid storage while minimizing storage lipid consumption. Diverse strategies have been developed to accomplish this objective, including interfering with storage lipid turnover, eliminating competing metabolic pathways that siphon carbon away from lipid biosynthesis and selecting for strains with enhanced lipid production capabilities by adaptive laboratory evolution (ALE). Engineering Y. lipolytica to handle specific plastic-associated lipogenesis inhibitors can potentially increase the product titer. For example, introducing genes that help with organophosphate degradation improved cell lipid content. Alternatively, modifying the composition of the growth medium can also increase the efficiency of lipogenesis. Patel and Matsakas (2019) reported that sonication of waste cooking oil increased the yield of single cell oils by shortening the chain length of fatty acids in the growth substrate. In general, developing a collection of plastic-adapted oleaginous yeast will be essential for using plastic waste as an input for single cell oil production.

Fatty acid profiles for Y. lipolytica cells grown in OP5 or PCOP5 media: Intracellular FA profiles for Y. lipolytica cells grown on OP5 and PCOP5 for 120 hours were analyzed. FA profiles were not complex for cells grown on either media, with only 4 FAs detected in each FA profile. Palmitic acid was the dominant FA on both OP5 and PCOP5, at 72 percent of FAs detected on OP5 grown cells and 81 percent for PCOP5 grown cells. Pentadecanoic acid was present in OP5 grown cells, with 8.1 percent of the FA profile detected, but it was not present in PCOP5 grown cells. Overall, FA profiles did not differ significantly when cells were grown on OP5 versus PCOP5 medium.

Discussion: Microbial bioconversion has potential for upcycling plastic waste into value-added biochemicals. In the previous example, it was demonstrated that thermal depolymerization of PP could be used to make a microbial growth medium suitable for Y. lipolytica to grow and produce fatty acids. In the present example, an improved PP-derived medium that did not require oleic acid as an emulsifier was developed. By removing oleic acid, the amount of carbon derived from PP increased from 51 percent in OP4 medium to 80 percent in OP5 medium. Additionally, by optimizing the fermentation conditions, the lipid yield was more than 4 times greater compared to the yield when Y. lipolytica grew in OP4 medium. These improvements are significant advances in developing a biological process for PP upcycling.

Lipid storage by oleaginous yeast is a physiological adaptation to stress. This creates a challenge for maximizing the lipid yield because the per-cell lipid production is greatest when conditions for cell growth are poor, resulting in low biomass. Conversely, when conditions for cell growth are permissive, lipid storage is low. These behaviors were evident in the presented data in two places. First, a comparison between Y. lipolytica growth in OP4 medium versus OP5 medium demonstrated higher biomass accumulation during growth in OP4 medium but significantly greater cellular lipid content during growth in OP5 medium. These results correlate with the presence of easily assimilated oleic acid in OP4 medium, which was absent in OP5 medium. Second, at pH=4 and low inoculum density, a more stressful condition, growth was the least and lipid content per cell was the greatest; conversely at pH=6 and high inoculum density, a more permissive condition, growth was the greatest but lipid content per cell was the lowest. The highest overall lipid yield occurred at pH=6 and inoculum density of 3, a set of conditions which were intermediate relative to the others; it is notable that under these conditions, neither the growth nor the per-cell lipid content was the highest. These findings were comparable to previous studies, which showed that Y. lipolytica inoculum size affected both growth and product formation during fermentation, with lower inoculum density favoring higher cellular lipid content and higher inoculum density favoring biomass growth.

It was decided to pursue a higher lipid yield by using as a starting point the inoculum density and pH that were most effective and then optimizing additional variables. Several environmental factors have been demonstrated to affect product formation in Y. lipolytica, including the C/N ratio and the osmolarity of the medium. A C/N ratio greater or equal to 80 resulted in an additional increase in lipid yield; higher C/N ratios signal nitrogen scarcity, often resulting in lipid storage. In contrast, increasing osmolarity, which significantly influences erythritol formation in Y. lipolytica, did not have a positive effect of lipid formation. Overall, parameter optimization resulted in a greater than 4-fold increase in lipid yield compared to the original cultivation conditions.

To simulate the real-world applicability of the present process, postconsumer PP which, unlike amorphous virgin PP, contains additives to promote stability and longevity was investigated. Some of the most common additives used in PP packaging include antioxidants, slip agents and heat stabilizers. It was determined that growth was not adversely affected during growth in PCOP5 medium, but lipid yields were significantly reduced compared to growth in OP5 medium. It was hypothesized that heavy metal-based slip agents and organophosphate antioxidants, compounds used to delay oxidative stress caused by UV radiation, may be impeding lipogenesis in Y. lipolytica. It has been shown that antioxidants can impede lipogenesis in hepatocytes by preventing reactive oxygen species from inducing lipid accumulation. Heavy metals such as cadmium, tin, and lead have also been shown to increase ER stress and lipid peroxidation in eukaryotic cells, and might be negatively influencing Y. lipolytica lipogenesis.

What approaches can be pursued to upcycle postconsumer PP and to further increase the product yield? In addition to optimizing growth conditions, altering the Y. lipolytica genome may be beneficial. Introducing heterologous organophosphate hydrolase genes may assist Y. lipolytica in degrading organophosphate additives, possibly increasing lipid accumulation. Engineered metabolite detoxification has been used elsewhere; for example, introduction of an exogenous gene to decrease inhibitory xylose concentrations improved lignocellulose bioconversion. A similar strategy may benefit PP bioconversion. The impact of heavy metals on Y. lipolytica activity is not well understood, outside of their effects on Y. lipolytica dimorphism and biofilm formation. Steps to mitigate their impact on fatty acid production could include incorporating the DMT1 gene, a divalent metal ion transporter gene that mitigates cadmium uptake in rodent intestines, into the Y. lipolytica genome. Additionally, several metabolic engineering strategies have been investigated to improve cell lipid content. These include introduction of loss of function mutations to lipid catabolism genes, and overexpression of native lipogenesis genes. In general, there are several approaches that can be employed to improve the lipid yield and the potential for a biological process for plastic upcycling warrants additional investigation.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative materials and method steps disclosed herein are specifically described, other combinations of the materials and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed. As used in this disclosure and in the appended claims, the singular forms “a”, “an”, “the”, include plural referents unless the context clearly dictates otherwise.

1. A method of bioconverting a polyalkylene containing plastic material, the method comprising:
(a) pyrolyzing the polyalkylene containing plastic material to obtain a depolymerized residue;
(b) optionally mixing the depolymerized residue with an adjuvant selected from a surfactant, a nitrogen source, a phosphate source, a carbohydrate source, a source of mineral, or a combination thereof, to form a culture medium, wherein when used, the surfactant comprises a synthetic nonionic biodegradable surfactant;
(c) introducing an enzyme or an organism into the culture medium; and
(d) accumulating at least one product produced by the enzyme or the organism.

2. The method of claim 1, wherein step (c) comprises introducing an enzyme or an organism that expresses a fatty acid biosynthetic pathway; enhances metabolism of polyalkylene residues; increases flux of poly alkylene-derived compounds through fatty acid biosynthetic pathways; increases the uptake of polyalkylene residues from the medium; or combinations thereof.

3. The method of claim 1, wherein step (c) comprises introducing an organism comprising a gene, the gene encoding an enzyme that enhances metabolism of polyalkylene residues or encoding essential enzymes to increase flux of polyalkylene-derived compounds through fatty acid biosynthetic pathways.

4. The method of claim 1, wherein step (c) comprises introducing an organism comprising a gene, the gene encoding a transport protein that increases the uptake of polyalkylene residues from the medium.

5. The method of claim 1, wherein the organism is a recombinant organism, or a naturally occurring organism.

6. The method of claim 1, wherein the polyalkylene containing plastic material comprises polyethylene (including high density polyethylene and/or low density polyethylene), polypropylene (including high density polypropylene and/or low density polypropylene), or a combination thereof.

7. The method of claim 1, wherein the polyalkylene containing plastic material comprises at least 50% by weight, at least 70% by weight, or consists essentially of polypropylene.

8. The method of claim 1, wherein the polyalkylene containing plastic material is a post-consumer waste material.

9. The method of claim 1, wherein the polyalkylene containing plastic material is a plastic article, such as a plastic fibrous material, a plastic film, foam, or a cast or uncast plastic packaging material.

10. The method of claim 1, wherein pyrolyzing comprises heating a neat or heterologous mixture of the polyalkylene containing plastic material to a temperature of 350° C. or greater.

11. The method of claim 1, wherein the depolymerized residue comprises one or more branched C6-36 alcohols, one or more branched C₆₋₃₆ alkenes, or combinations thereof.

12. (canceled)

13. The method of claim 1, wherein
the culture medium comprises a carbon to nitrogen weight ratio of 2:1 to 10:1.

14. (canceled)

15. The method of claim 1, wherein the product produced comprises a fatty acid product.

16. The method of claim 1, wherein the product produced is not a polyhydroxyalkanoate.

17. A method of making a culture medium from a plastic material selected from polyester, polyurethane, or a combination thereof, the method comprising:
(a) heating the plastic material in an aqueous mixture having a pH of 10 or greater to obtain a depolymerized residue; and
(b) mixing the depolymerized residue with an adjuvant selected from a biodegradable surfactant, a nitrogen source, a phosphate source, a carbohydrate source, a source of mineral, or a combination thereof to form a culture medium having an acidic, neutral, or basic pH (such as pH 6.8-10).

18. A method of bioconverting a plastic material selected from polyester, polyurethane, or a combination thereof, the method comprising:
(a) depolymerizing by heating the plastic material in an aqueous mixture having a pH of 10 or greater to obtain a depolymerized residue;
(b) mixing the depolymerized residue with an adjuvant selected from a surfactant, a nitrogen source, a phosphate source, a carbohydrate source, a source of mineral, or a combination thereof to form a culture medium;
(c) introducing an enzyme or an organism into the culture medium; and
(d) accumulating a product produced by the enzyme or the organism.

19-36. (canceled)

37. A method of making a culture medium from a polystyrene containing plastic material, the method comprising:
(a) depolymerizing the polystyrene containing plastic material in a mixture comprising two or more of an oxidizing agent, styrene oxide, or acetone to obtain a depolymerized residue; and
(a) mixing the depolymerized residue with an adjuvant selected from a biodegradable surfactant, a nitrogen source, a phosphate source, a carbohydrate source, a source of mineral, or a combination thereof to form a culture medium having a basic pH.

38. A method of bioconverting a polystyrene containing plastic material, the method comprising:
(a) depolymerizing the polystyrene containing plastic material in a mixture comprising two or more of an oxidizing agent, styrene oxide, or acetone to obtain a depolymerized residue;
(b) mixing the depolymerized residue with an adjuvant selected from a surfactant, a nitrogen source, a phosphate source, a carbohydrate source, a source of mineral, or a combination thereof to form a culture medium;
(c) introducing an enzyme or an organism into the culture medium; and
(d) accumulating at least one product produced by the enzyme or the organism.

39-53. (canceled)

54. A fatty acid composition prepared by a method according to claim 1.

55. (canceled)

56. A culture medium prepared by a method according to claim 1.

57-77. (canceled)
